(19) United States
(12) Patent Application Publication
(10) Pub. No.: US 2010/0033460 A1
(43) Pub. Date: Feb. 11, 2010

(54) DISPLAY DEVICE

(76) Inventor: Takaji Numao, Osaka (JP)

Correspondence Address: HARNESS, DICKEY & PIERCE, P.L.C., P.O. BOX 8910, RESTON, VA, 20195, US

(21) Appl. No.: 12/449,031

(22) PCT Filed: Nov. 19, 2007
(86) PCT No.: PCT/JP2007/072348

§ 371 Date: Jul. 21, 2009

(30) Foreign Application Priority Data
May 25, 2007 (JP) 2007-138620

(51) Int. Cl. G09G 5/00; H04N 5/66

(52) U.S. Cl. 345/211; 348/739; 348/E05.133

(57) ABSTRACT

A first switching element Q6 is provided between a source line Sj and a voltage selection circuit 14, and second switching elements Q2 and Q4 are provided between sectional lines Sj(2) to Sj(0) formed by dividing the source line Sj. During a voltage application period, the first switch is turned ON and the second switches are turned ON or OFF, so that voltage according with bits in video data Din is applied to the sectional lines. During a voltage averaging period, the first switch is turned OFF and the second switches are turned ON, so that voltage on the source line Sj is equivalent to an average of the voltage applied to the sectional lines. The averaged voltage is applied to a pixel electrode Pij in a pixel circuit Aij including an active element Q1 in ON state. Thus, there are provided low-power consumption, high-yield display devices allowing the source lines to be driven without using operational amplifier circuits.

### TECHNICAL FIELD

The present invention relates to display devices for providing a gradation display, particularly to display devices using TFTs (Thin Film Transistors). The present invention is applicable to liquid crystal and organic EL (Electro Luminescence) display devices using CG (Continuous Grain) silicon or polysilicon TFTs.

### BACKGROUND ART

In recent years, liquid crystal display devices using CG silicon or polysilicon TFTs are employed in display portions of cell phones and mobile PCs. Liquid crystal display devices using CG silicon or polysilicon TFTs employ driver circuits configured in the same manner as in liquid crystal display devices using aSi (amorphous silicon) TFTs. As for mobile equipment, in order to reduce battery consumption and thereby to achieve prolonged use, it is important to reduce power consumption of the display portion. In this regard, there are conventionally known liquid crystal display devices as described below.

FIG. 41 is a block diagram illustrating the configuration of a liquid crystal display device described in Patent Document 1. The liquid crystal display device shown in FIG. 41 has a scanning signal line drive circuit (gate driver circuit) 112 and a video signal line drive circuit (source driver circuit) 113 mounted on an active matrix liquid crystal panel 111, and also has a display control circuit (controller) 114, a power supply circuit 115 and a common electrode drive circuit 116 mounted on an unillustrated control board.

The display control circuit 114 generates a horizontal synchronization signal HSY and a vertical synchronization signal VSY based on an externally supplied address signal ADw, and outputs the generated signals to the scanning signal line drive circuit 112. Also, the display control circuit 114 generates an amplifier deactivation control signal Cas, a control signal Csh, a clock signal CK, and digital image signals Dr, Dg, and Db based on the address signal ADw and image data Dv, and outputs the generated signals to the video signal line drive circuit 113.

As shown in FIG. 42, the video signal line drive circuit 113 includes a sampling latch circuit 121 for holding 6-bit image signals, a decoder circuit 122 for decoding n 6-bit image signals being held, and n reference voltage selection circuits 131 to 13n. The reference voltage selection circuits 131 to 13n receive 64 levels of voltage generated by a voltage division resistance 123 and supplied via 64 reference voltage bus lines L1 to L64, and bus line voltage according with the decoding result is supplied to n buffer circuits 151 to 15n.

Video signal lines (source lines) connected to output terminals OUT1 to OUTn receive output voltage of the buffer circuits 151 to 15n supplied via change-over switches 161 to 16n. In order to stop circuit operation, deactivation control circuits 141 to 14n are connected to power sources of the buffer circuits 151 to 15n. The deactivation control circuits 141 to 14n are used to shut off power supply to the buffer circuits 151 to 15n, making it possible to reduce power consumption of the liquid crystal display device.

FIG. 43 is a block diagram illustrating the configuration of a liquid crystal display device described in Patent Document 2. In the liquid crystal display device shown in FIG. 43, each source bus line (source line) 212 is divided into a plurality of sectional lines F1 to Fn, and switching elements E1 to E(n−1) are disposed between the sectional lines. When the switching elements E1 to E(i−1) are turned ON and the switching element Ei is turned OFF, a source bus line drive circuit (source driver circuit) 211 is required to only supply voltage to the sectional lines F1 to Fi, and is not required to supply voltage to the sectional lines F(i+1) to Fn. In this manner, by saving power required for charging/discharging any sectional line subsequent to a switching element in OFF state, it becomes possible to reduce power consumption of the liquid crystal display device.

Patent Documents 3 and 4 describe TFTs being disposed between divided source lines, as in Patent Document 2. Patent Document 3 describes a liquid crystal panel having divided data lines (source lines) in which switching elements 313 are disposed between divided data lines 311 and 312, as shown in FIG. 44, in order to switch between individual driving of upper and lower portions and non-individual driving. The same drive voltage is applied to the same line, thereby preventing deterioration in image quality between the upper and lower portions of the liquid crystal panel and between the left and the right.

Patent Document 4 describes switching elements 415 being disposed between source signal lines (source lines) 413 of a main panel 411 and source signal lines 414 of a sub-panel 412, as shown in FIG. 45. When only driving the main panel 411, the switching elements 415 are turned OFF so that the source signal lines 414 are disconnected from the source signal lines 413. By saving power required for charging/discharging the source signal lines 414, it becomes possible to reduce power consumption of the liquid crystal display device.

As described above, known methods for reducing power consumption of the liquid crystal display device include methods in which the buffer circuit for driving the source lines is deactivated (Patent Document 1), unused source lines are not charged/discharged (Patent Document 2), and the source lines of the sub-panel are not charged/discharged when it is not necessary (Patent Document 4).
[Patent Document 1] Japanese Laid-Open Patent Publication No. 2003-302951
[Patent Document 2] Japanese Laid-Open Patent Publication No. 2003-344823
[Patent Document 3] Japanese Laid-Open Patent Publication No. 2002-287721
[Patent Document 4] Japanese Laid-Open Patent Publication No. 2005-234056
[Patent Document 5] Japanese Laid-Open Patent Publication No. 10-190377

### DISCLOSURE OF THE INVENTION

### Problems to be Solved by the Invention

However, the source driver circuits of conventional liquid crystal display devices include a buffer circuit for driving source lines. The buffer circuit is typically configured by short-circuiting an output terminal and an inverting input terminal of an operational amplifier circuit. Patent Document 5 describes a circuit shown in FIG. 46 as an exemplary operational amplifier circuit.

The operational amplifier circuit shown in FIG. 46 includes a differential input circuit 511, and outputs voltage from an output terminal OUT in accordance with a difference in potential between input terminals IN1 and IN2. Accordingly, by short-circuiting the input terminal IN2 and the output terminal OUT, the difference in potential between the input terminal IN1 and the output terminal OUT is stabilized at approximately 0. However, the potential at the input terminals IN1 and IN2 is between power source potential Vcc and ground potential GND, and therefore current constantly flows through FETs N11, N12, and N41, for example.

In this manner, in the case of liquid crystal display devices using operational amplifier circuits (or buffer circuits) for driving source lines, a considerable amount of current flows between power sources of the operational amplifier circuits. Therefore, to reduce such current as much as possible, the aforementioned methods, methods for lowering the power source voltage, or such like are used. From this, it can be appreciated that, to reduce power consumption of the liquid crystal display device, the source lines are simply driven without using operational amplifier circuits (and buffer circuits).

Also, in differential input circuits included in the operational amplifier circuits (and the buffer circuits), output voltage offset variations occur due to variations in characteristics (e.g., threshold and mobility) among FETs. Since the source driver circuit includes a number of operational amplifier circuits in accordance with the number of output terminals, there is a difficulty in externally adjusting offset voltage of the operational amplifier circuits. Therefore, offset voltage variations cause yield reduction of source driver circuits.

Therefore, an objective of the present invention is to provide low-power consumption, high-yield display devices in which gradation voltage is generated to drive source lines (data signal lines) without using operational amplifier circuits (and buffer circuits).

### Solution to the Problems

A first aspect of the present invention is directed to a display device for providing a gradation display based on video data, comprising: a plurality of scanning signal lines; a plurality of data signal lines; and a plurality of pixel circuits disposed at corresponding intersections of the scanning signal lines and the data signal lines, wherein provided for each of the data signal lines are: a plurality of capacitances, including a capacitance formed by the data signal line, a first switching element provided between the capacitance and a fixed-potential line; and a second switching element provided between the capacitances.

In a second aspect of the present invention, based on the first aspect of the invention, two or more of the capacitances are formed by dividing the data signal line.

In a third aspect of the present invention, based on the second aspect of the invention, at least part of the second switching element is disposed between the divided data signal lines, and a control line for the second switching element disposed the position is spaced from an adjacent scanning signal line at approximately the same distance as that between the scanning signal lines.

In a fourth aspect of the present invention, based on the first aspect of the invention, the fixed-potential line is provided in a plurality.

In a fifth aspect of the present invention, based on the first aspect of the invention, the device further comprises capacitance lines crossing the data signal lines.

In a sixth aspect of the present invention, based on the first aspect of the invention, during a voltage application period, the second switching element is turned ON or OFF, so that voltage according with the video data is applied to each of the capacitances, during a voltage averaging period, the first switching element is turned OFF and the second switching element is turned ON, so that the voltage applied to the capacitances is averaged, and the averaged voltage is applied to a pixel electrode in a pixel circuit including an active element in ON state.

It is often the case that video data is inputted to a display device using a format in which video data which correspond to each pixel circuit and has a plurality of bits is sequentially transferred.

On the other hand, in a seventh aspect of the present invention, based on the first aspect of the invention, the video data is inputted using a format in which equally weighted portions are collected from plural pieces of numerical data and sequentially transferred.

### EFFECT OF THE INVENTION

According to the first aspect of the present invention, the second switching element is controlled to be turned OFF while sequentially applying voltage to k capacitances (where k is an integer of 2 or more) which correspond to each data signal line, so that different levels of voltage can be held in the k capacitances. When voltage having any of M levels (where M is an integer of 2 or more) is held in each capacitance, the first and second switching elements are controlled to be turned OFF and ON, respectively, so that the voltage held in the k capacitances can be averaged, and a desired voltage selected from among the k'th power of M voltage levels, can be applied to the data signal lines. Furthermore, the averaged voltage can be applied to the pixel circuits, thereby bringing the pixel circuits into desired display state.

Accordingly, it is possible to generate gradation voltage according with video data and apply the generated voltage to the pixel circuits, thereby displaying desired video, without using operational amplifier circuits and buffer circuits. In addition, since neither operational amplifier circuits nor buffer circuits are used, it is possible to eliminate current constantly flowing between power sources of operational amplifier circuits, thereby reducing power consumption, and realizing display devices at high yield and at low cost.

One of the capacitances can be formed by the data signal line. Also, according to the second aspect of the present invention, a plurality of capacitances can be formed by dividing the data signal line. When data signal lines are divided into two pieces, ¾ of the total required capacitance can be formed using the data signal lines, and therefore it is possible to reduce the area in which to form the capacitances.

In the case of dividing the data signal lines, at least part of the second switching element is disposed inside the display area. Therefore, some contrivance is required to allow the second switching element to be less conspicuous when disposed inside the display area.

According to the third aspect of the present invention, it is possible to render the presence of a control line for the second switching element less conspicuous among the scanning signal lines from the perspective of arrangement intervals.

According to the fourth aspect of the present invention, capacitances are connected to fixed-potential lines corresponding to video data, so that voltage according with the video data can be applied to the capacitances. Furthermore, voltage held in the capacitances is averaged, making it possible to display desired video.

According to the fifth aspect of the present invention, voltage on the capacitance lines are changed, thereby changing voltage on the data signal lines.

According to the sixth aspect of the present invention, voltage according with video data is applied to the capacitances, the voltage applied to the capacitances is averaged, and the obtained voltage is applied to pixel electrodes, thereby displaying desired video.

According to the seventh aspect of the present invention, 1-bit registers are disposed in a data signal line driver circuit in association with their corresponding data signal lines, making it possible to apply different levels of voltage to k capacitances based on data accumulated in each register. Thus, the circuit complexity of the data signal line driver circuit is reduced, making it possible to realize display devices at high yield and at low cost.

As described above, the display device of the present invention provides a gradation display without using operational amplifier circuits and buffer circuits, and also enables elimination of current flowing between power sources of operational amplifier circuits, thereby making it possible to achieve low-power consumption display devices. Furthermore, the display device is free of the influence of variations in transistor characteristics, making it possible to increase device yield, thereby achieving cost reduction.

### BRIEF DESCRIPTION OF THE DRAWINGS

FIG. 1 is a block diagram illustrating the configuration of a display device according to a first embodiment of the present invention.

FIG. 2 is an equivalent circuit diagram for a pixel circuit of the display device shown in FIG. 1.

FIG. 3 is an equivalent circuit diagram for a pixel circuit of the display device shown in FIG. 1.

FIG. 4 is an equivalent circuit diagram for a pixel circuit of the display device shown in FIG. 1.

FIG. 5 is a block diagram illustrating in detail a voltage selection circuit of the display device shown in FIG. 1.

FIG. 6 is a table illustrating selection outputs of the voltage selection circuit shown in FIG. 5.

FIG. 7 is an equivalent circuit diagram for a lower-order bit circuit of the display device shown in FIG. 1.

FIG. 8 is a timing chart for the display device shown in FIG. 1.

FIG. 9 is a diagram illustrating voltage on sectional lines of the display device shown in FIG. 1.

FIG. 10 is a diagram illustrating voltage on sectional lines of the display device shown in FIG. 1.

FIG. 11 is a diagram illustrating voltage on sectional lines of the display device shown in FIG. 1.

FIG. 12 is a diagram illustrating voltage on source lines of the display device shown in FIG. 1.

FIG. 13 is a table illustrating the relationship between voltage on sectional lines and voltage on source lines of the display device shown in FIG. 1.

FIG. 14 is a timing chart illustrating a video data transfer format for the display device shown in FIG. 1.

FIG. 15 is a block diagram illustrating the configuration of a display device according to a second embodiment of the present invention.

FIG. 16 is an equivalent circuit diagram for a pixel circuit of the display device shown in FIG. 15.

FIG. 17 is an equivalent circuit diagram for a lower-order bit circuit of the display device shown in FIG. 15.

FIG. 18 is a timing chart for the display device shown in FIG. 15.

FIG. 19 is a block diagram illustrating the configuration of a display device according to a third embodiment of the present invention.

FIG. 20 is a block diagram illustrating in detail a voltage selection circuit of the display device shown in FIG. 19.

FIG. 21 is a timing chart illustrating a video data transfer format for the display device shown in FIG. 19.

FIG. 22 is a block diagram illustrating the configuration of a display device according to a fourth embodiment of the present invention.

FIG. 23 is an equivalent circuit diagram for a pixel circuit of the display device shown in FIG. 22.

FIG. 24 is an equivalent circuit diagram for a pixel circuit of the display device shown in FIG. 22.

FIG. 25 is an equivalent circuit diagram for a pixel circuit of the display device shown in FIG. 22.

FIG. 26 is an equivalent circuit diagram for a pixel circuit of the display device shown in FIG. 22.

FIG. 27 is a block diagram illustrating in detail a voltage selection circuit of the display device shown in FIG. 22.

FIG. 28 is a table illustrating selection outputs of the voltage selection circuit shown in FIG. 27.

FIG. 29 is an equivalent circuit diagram for a lower-order bit circuit of the display device shown in FIG. 22.

FIG. 30 is a timing chart for the display device shown in FIG. 22.

FIG. 31 is a diagram illustrating voltage on sectional lines of the display device shown in FIG. 22.

FIG. 32 is a diagram illustrating voltage on sectional lines of the display device shown in FIG. 22.

FIG. 33 is a diagram illustrating voltage on sectional lines of the display device shown in FIG. 22.

FIG. 34 is a diagram illustrating voltage on sectional lines of the display device shown in FIG. 22.

FIG. 35 is a diagram illustrating voltage on sectional lines of the display device shown in FIG. 22.

FIG. 36 is a diagram illustrating voltage on sectional lines of the display device shown in FIG. 22.

FIG. 37 is a diagram illustrating voltage on source lines of the display device shown in FIG. 22.

FIG. 38 is a table illustrating the relationship between voltage on sectional lines and voltage on source lines of the display device shown in FIG. 22.

FIG. 39 is an equivalent circuit diagram for a pixel circuit of a display device according to an embodiment of the present invention.

FIG. 40 is an equivalent circuit diagram for a pixel circuit of a display device according to an embodiment of the present invention.

FIG. 41 is a block diagram illustrating the configuration of a conventional liquid crystal display device (first example).

FIG. 42 is a block diagram illustrating the configuration of a video signal line driver circuit of the liquid crystal display device shown in FIG. 41.

FIG. 43 is a block diagram illustrating the configuration of a conventional liquid crystal display device (second example).

FIG. 44 is a block diagram illustrating the configuration of a conventional liquid crystal display device (third example).

FIG. 45 is a block diagram illustrating the configuration of a conventional liquid crystal display device (fourth example).

FIG. 46 is a circuit diagram for an operational amplifier circuit of a conventional liquid crystal display device.

### DESCRIPTION OF THE REFERENCE CHARACTERS

1, 2, 3, 4 display device
7 gate driver circuit
8 shift register
9 gate output circuit
10, 20, 40 display area
11, 21, 31, 41 source driver circuit
12, 32 shift register
13, 33 register
14, 34, 44 voltage selection circuit
15, 25, 45 lower-order bit circuit
16, 36, 46 latch
17, 37, 47 selection circuit
51, 52 pixel circuit
G1 gate line
Sj source line
Sj(2) to Sj(0) sectional line
Ui auxiliary capacitance line
E2 to E0, P1 control line
H2 to H0 capacitance line
VH, VL fixed-potential line
LP latch pulse
Rv polarity control signal
Sx bit selection signal
Aij pixel circuit
Pij pixel electrode
Lc liquid crystal element
Q1 to Q8, Q21 to Q24, Q41 to Q46, Q51, Q52 TFT
Cs auxiliary capacitance
Cp, C1 to C10, Cj(1) to Cj(0), Ct capacitor
OL organic EL element
Vp power source line

### BEST MODE FOR CARRYING OUT THE INVENTION

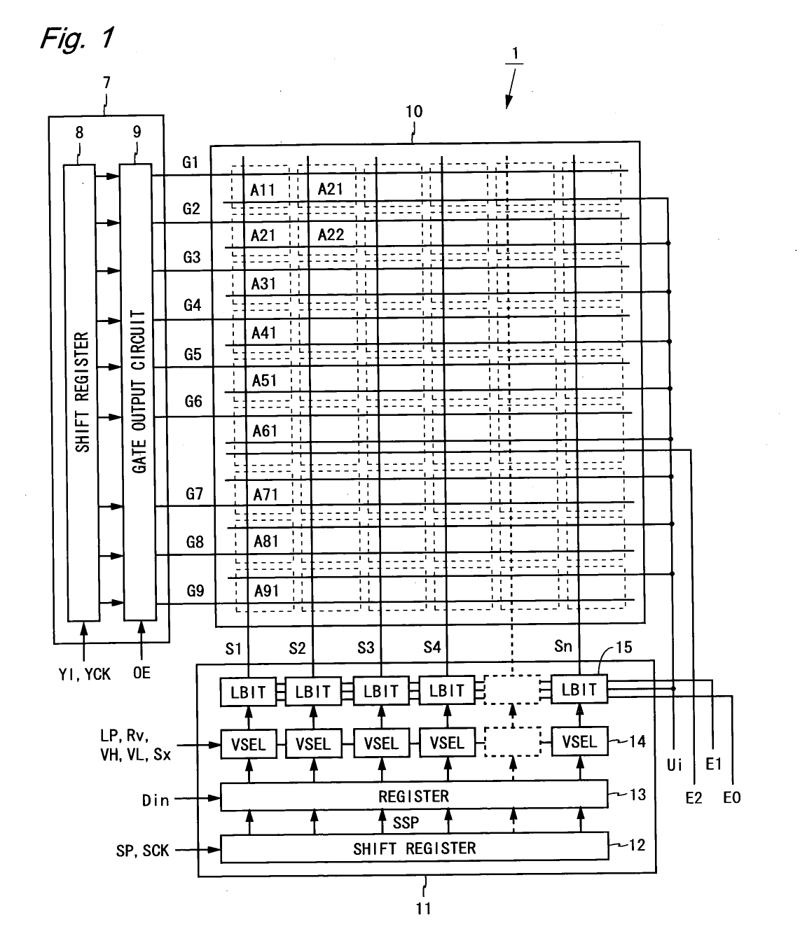

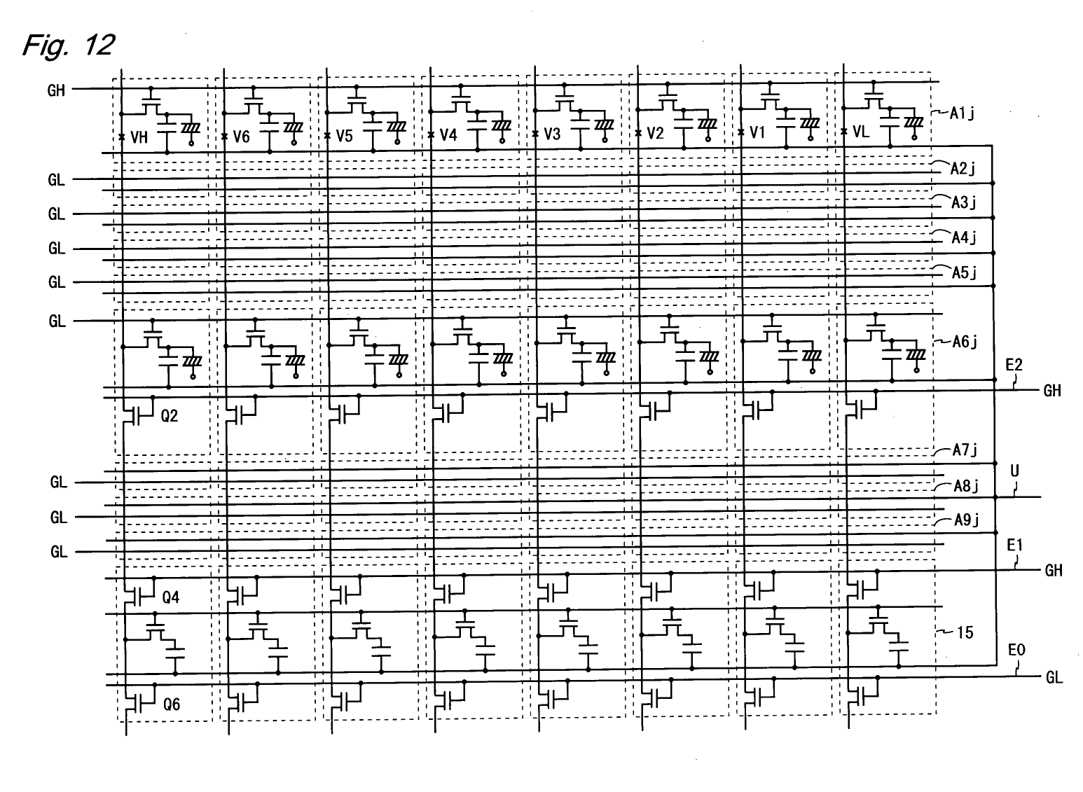

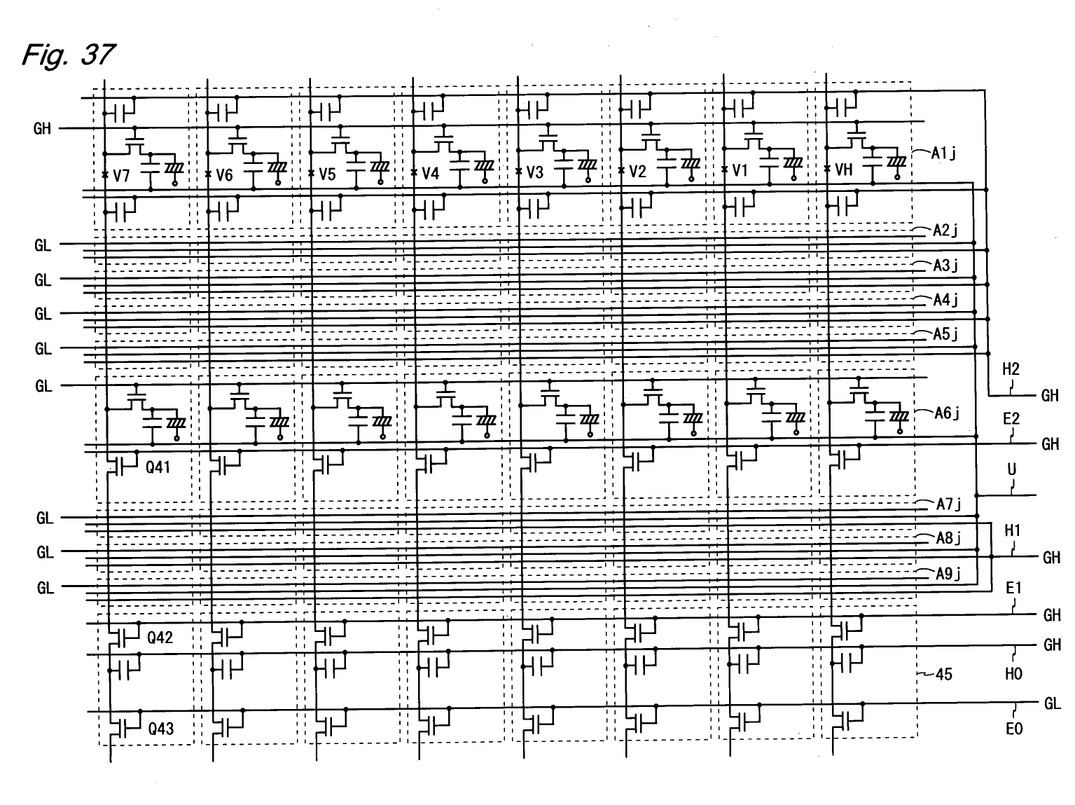

Hereinafter, display devices according to embodiments of the present invention will be described with reference to FIGS. 1 to 40. In the following description, the display devices are liquid crystal display devices including (m×n) pixels (m and n are integers of 2 or more), and the number of bits in video data to be provided to the display devices is 3. Also, the bits in the video data are referred to as, from the highest order, second, first, and zeroth bits, respectively. Note that the present invention is applicable to various display devices regardless of, for example, the number of pixels, the number of bits in video data, the type of display element.

### First Embodiment

FIG. 1 is a block diagram illustrating the configuration of a display device according to a first embodiment of the present invention. The display device 1 shown in FIG. 1 includes a display area 10, a gate driver circuit 7, and a source driver circuit 11. The display device 1 provides an 8-level gradation display based on 3-bit video data Din.

The display area 10 is provided with m gate lines G1 (where i is an integer from 1 to m; in FIG. 1, m=9) and n source lines Sj (where j is an integer from 1 to n). The gate lines G1 are disposed in parallel to each other, and the source lines Sj are disposed in parallel to each other and perpendicular to the gate lines G1. Pixel circuits Aij are disposed near intersections of the gate lines G1 and the source lines Sj. The gate lines are also referred to as “scanning signal lines”, the source lines are also referred to as “data signal lines”, and the pixel circuits Aij each correspond to a single pixel.

In FIG. 1, the source lines Sj are each shown as a single line, but in fact, they are each divided into three sectional lines Sj(2) to Sj(0) in accordance with the number of bits (3 bits) in video data. The sectional lines Sj(2) to Sj(0) correspond to the second to zeroth bits, respectively, in video data. The sectional lines Sj(2) and Sj(1) are disposed inside the display area 10, and the sectional line Sj(0) is disposed outside the display area 10.

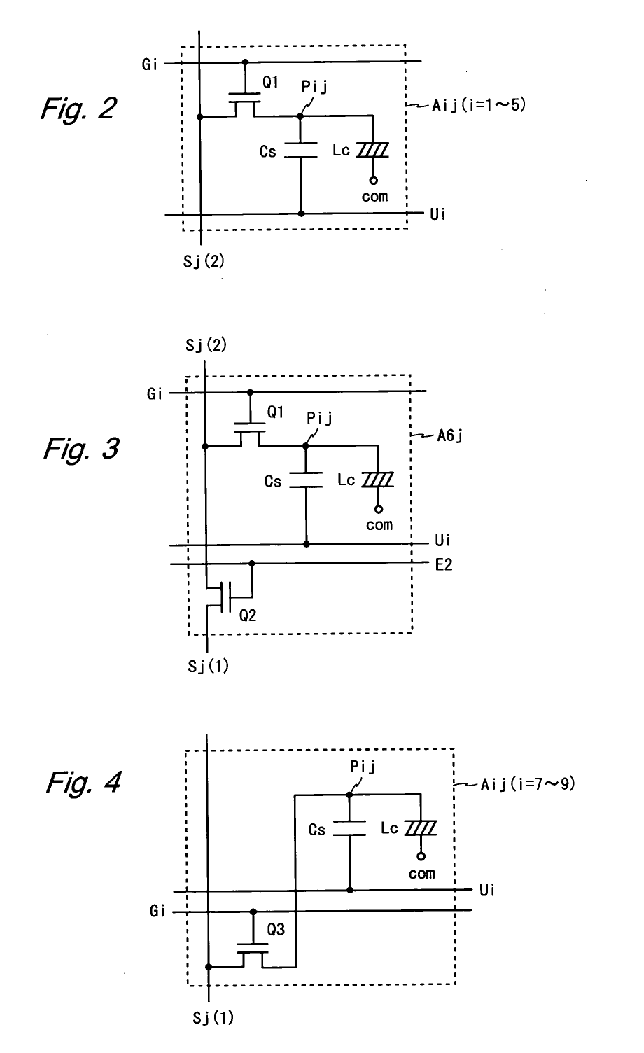

The pixel circuits Aij vary in circuit configuration in accordance with the row number i. In the display device 1, the pixel circuits A1j to A5j have a circuit configuration as shown in FIG. 2, the pixel circuit A6j has a circuit configuration as shown in FIG. 3, and the pixel circuits A7j to A9j have a circuit configuration as shown in FIG. 4. The pixel circuit shown in FIG. 2 includes a TFT Q1, which is an active element, a liquid crystal element Lc, which is a display element, and a capacitor Cs. The TFT Q1 is an n-type TFT and has a gate terminal connected to the gate line G1, a source terminal connected to the sectional line Sj(2), and a drain terminal connected to a pixel electrode Pij. The pixel electrode Pij serves as one of the terminals of the capacitor Cs, and the other terminal of the capacitor Cs is connected to an auxiliary capacitance line Ui.

The pixel circuit shown in FIG. 3 is a pixel circuit as shown in FIG. 2 to which a TFT Q2 is added as a second switching element. The TFT Q2 is an n-type TFT disposed between the sectional lines Sj(2) and Sj(1). The TFT Q2 has a gate terminal connected to a control line E2. The pixel circuit shown in FIG. 4 includes a TFT Q3, which is an active element, a liquid crystal element Lc, which is a display element, and a capacitor Cs. The pixel circuit shown in FIG. 4 is configured in the same manner as that shown in FIG. 2 but differs therefrom in that the source terminal of the TFT Q3 is connected to the sectional line Sj(1) and the TFT Q3 is disposed opposite to the liquid crystal element Lc with respect to the gate line G1.

In the display area 10, the gate lines G1 to G6 are disposed at regular intervals, and the gate lines G7 to G9 are disposed at the same intervals as well. The gate lines G6 and G7 are spaced at twice the interval, and the control line E2 is disposed at an approximate midpoint between the gate lines G6 and G7. Accordingly, the distance between the control line E2 for the TFT Q2, which is a second switch, and the gate lines G6 and G7 adjacent thereto is approximately the same as the distance between the gate lines G1 to G6 and the distance between the gate lines G7 to G9.

The gate driver circuit 7 includes an m-bit shift register 8 and a gate output circuit 9 for m bits. The shift register 8 sequentially transfers a start pulse Y1 in accordance with a clock YCK. The gate output circuit 9 performs a logical operation between outputs from the shift register 8 and an output enable signal OE, and applies selection voltage GH (high) or deselection voltage GL (low) to the gate lines G1. As a result, the gate lines G1 are sequentially selected one by one.

The source driver circuit 11 includes an n-bit shift register 12, an (n×3)-bit register 13, n voltage selection circuits 14 each having a 3-bit latch, and n lower-order bit circuits 15. A start pulse SP is supplied to the first stage of the shift register 12. The shift register 12 sequentially transfers the start pulse SP in accordance with a clock SCK. The shift register 12 provides its outputs to the register 13 as timing pulses SSP. When the j-th timing pulse SSP is outputted, the register 13 holds 3-bit video data Din in a position corresponding to the source line Sj.

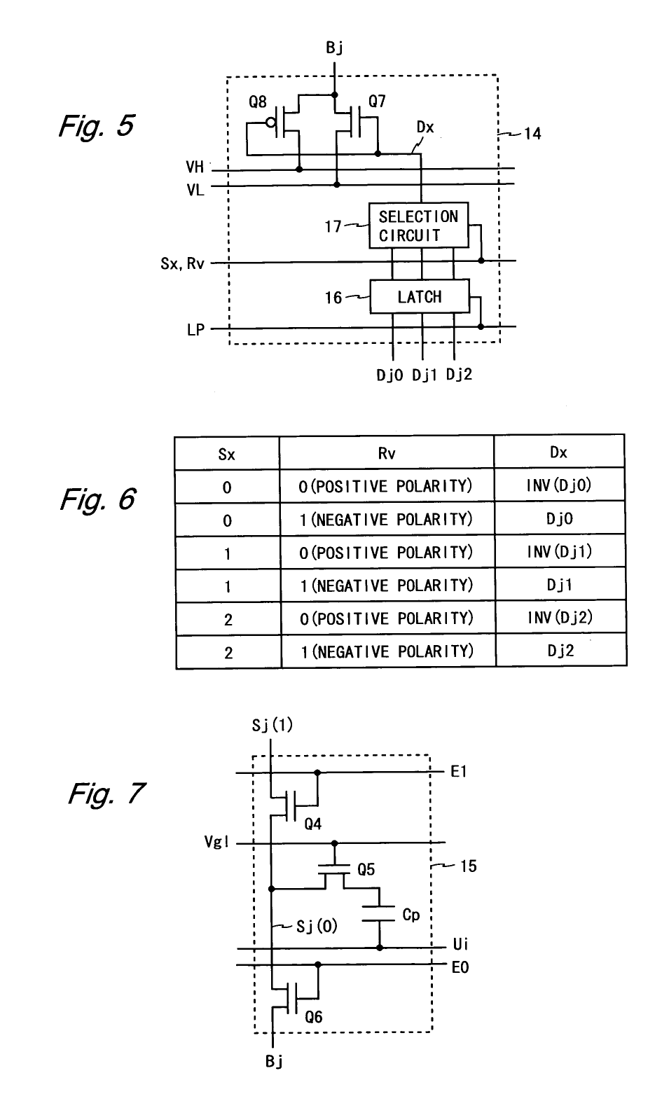

FIG. 5 is a block diagram illustrating the voltage selection circuit 14 in detail. In FIG. 5, a latch 16 is a 3-bit latch for taking in, in accordance with a latch pulse LP, 3-bit data Dj2 to Dj0 held in the register 13. The selection circuit 17 selects, in accordance with a bit selection signal Sx, 1-bit data from the 3-bit data held in the latch 16, and outputs the selected data with a polarity in accordance with a polarity control signal Rv. A selection output Dx of the selection circuit 17 is determined as shown in FIG. 6 based on the bit selection signal Sx, the polarity control signal Rv, and the 3-bit data Dj2 to Dj0. Note that INV(X) denotes an inversion of X.

In the voltage selection circuit 14, a TFT Q7 is disposed between an output terminal Bj and a line with a fixed potential VL, and a TFT Q8 is disposed between the output terminal Bj and a line with a fixed potential VH. The TFT Q7 is an n-type TFT, the TFT Q8 is a p-type TFT, and the selection output Dx is provided to gate terminals of the TFTs Q7 and Q8. When the selection output Dx is 1 (high), the voltage VL is outputted from the output terminal Bj, and when the selection output Dx is 0 (low), the voltage VH is outputted from the output terminal Bj.

FIG. 7 is an equivalent circuit diagram for the lower-order bit circuit 15. The lower-order bit circuit 15 has an input terminal Bj connected to the output terminal Bj of the voltage selection circuit 14, and the lower-order bit circuit 15 has the sectional line Sj(0) disposed therein. A TFT Q6, which is a first switching element, is disposed between the input terminal Bj and the sectional line Sj(0), and a TFT Q4, which is a second switching element, is disposed between the sectional line Sj(0) and the sectional line Sj(1). Also, a TFT Q5 and a capacitor Cp are provided, forming a line capacitance on the sectional line Sj(0), which equals to half of the line capacitance on the sectional line Sj(1). The TFTs Q4 to Q6 are n-type TFTs, and the TFTs Q4 and Q6 have their gate terminals connected to control lines E1 and E0, respectively. The TFT Q5 is provided with gate low voltage Vg1 at its gate terminal.

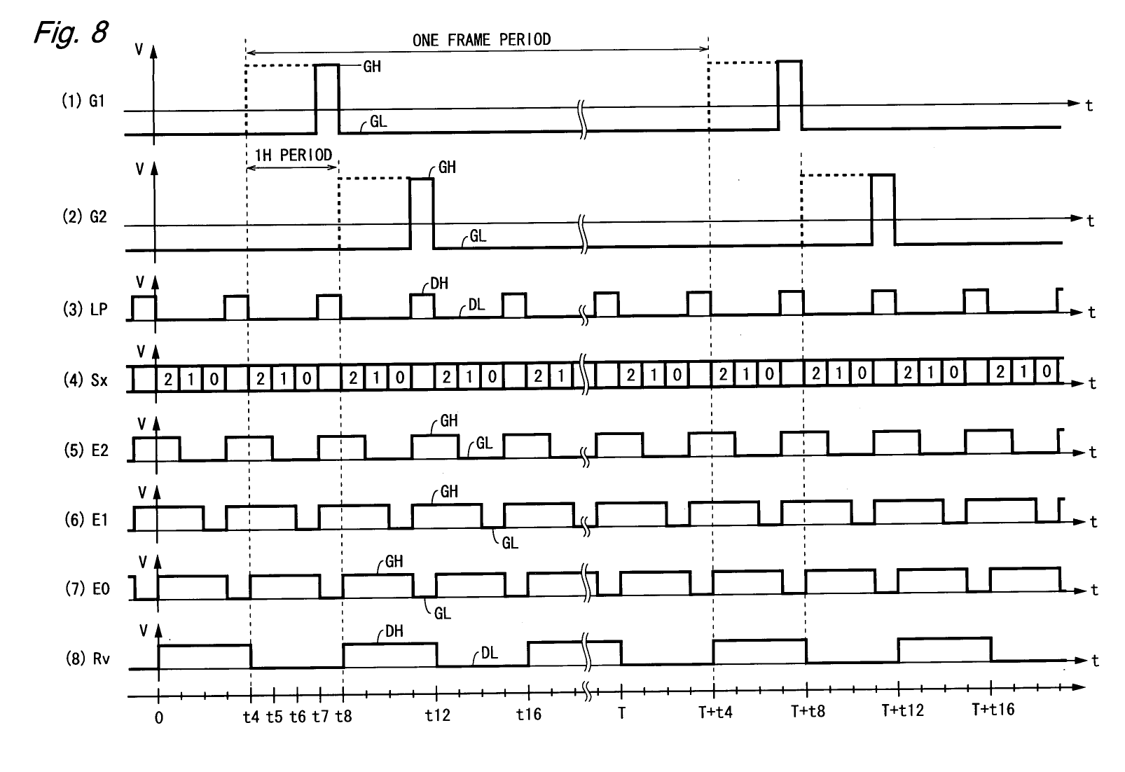

FIG. 8 is a timing chart for the display device 1. Hereinafter, a signal on the gate line is referred to as a “gate signal”, and a signal on the control line is referred to as a “control signal”. FIG. 8 shows changes of gate signals G1 and G2 in (1) and (2), respectively, a latch pulse LP in (3), a bit selection signal Sx in (4), control signals E2 to E0 in (5) to (7), respectively, and a polarity control signal Rv in (8). In FIG. 8, T denotes the length of one frame period, and tk denotes a time point after a lapse of k sub-periods from time point 0 within one horizontal period divided into four sub-periods. Note that the sub-periods may be equal or different in length.

Referring to FIGS. 8 to 13, the operation of the display device 1 during one horizontal period (time points t4 to t8) for the gate line G1 will be described. One horizontal period is divided into a voltage application period (time points t4 to t7) and a voltage averaging period (time points t7 to t8). The gate signal G1 is GH from time points t7 to t8, and GL for the rest of the period. The latch pulse LP is DH (high) from time points t7 to t8, and DL (low) for the rest of the period. The value of the bit selection signal Sx is 2 from time points t4 to t5, 1 from time points t5 to t6, and 0 from time points t6 to t7. The control signal E2 is GL from time points t5 to t7, and GH for the rest of the period. The control signal E1 is GL from time points t6 to t7, and GH for the rest of the period. The control signal E0 is GL from time points t7 to t8, and GH for the rest of the period. The polarity control signal Rv is GL from time points t4 to t8.

Generally, in each frame period, the gate signal G1 is GH during a portion of a certain horizontal period, and GL for the rest of the period. In each horizontal period, the latch pulse LP, the bit selection signal Sx, and the control signals E2 to E0 change in the same manner as they do from time points t4 to t8. The polarity control signal Rv changes between DH and DL every horizontal period, and the polarity thereof is inverted in the next frame period. For example, the polarity control signal Rv is DH during one horizontal period (time points t8 to t12) for the gate line G2, and DH during one horizontal period (time points (T+t4) to (T+t8)) for the gate line G1 in the next frame period.

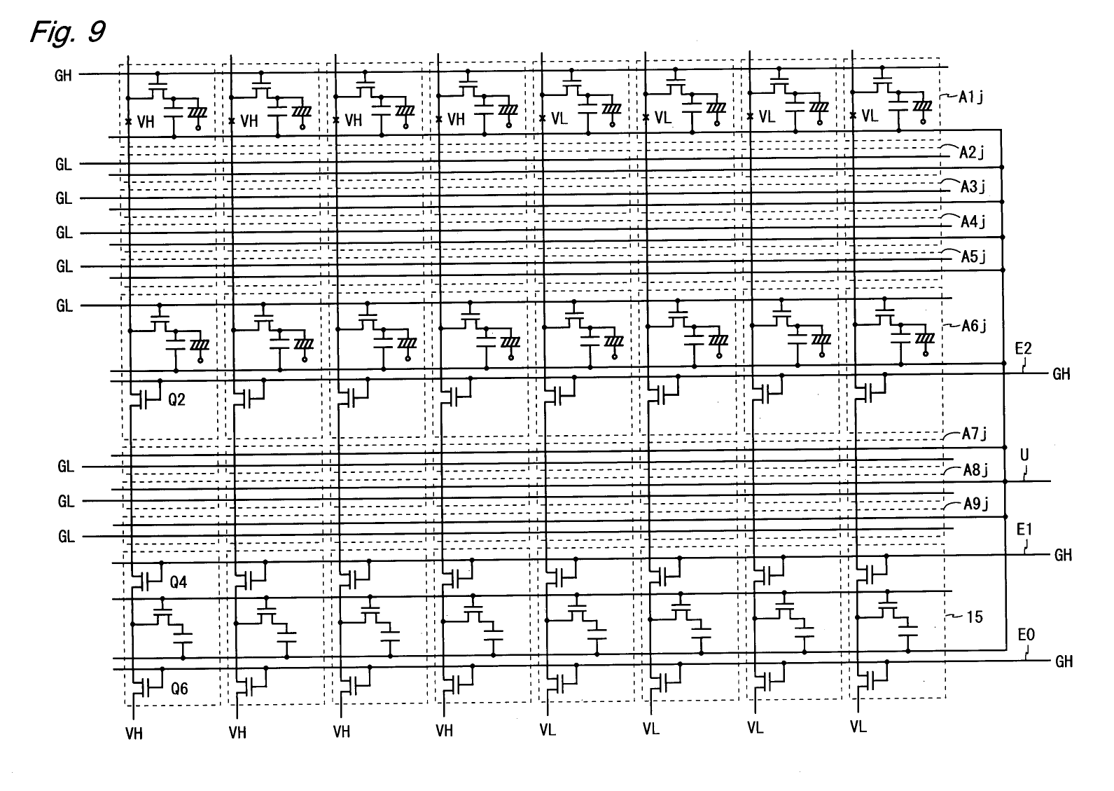

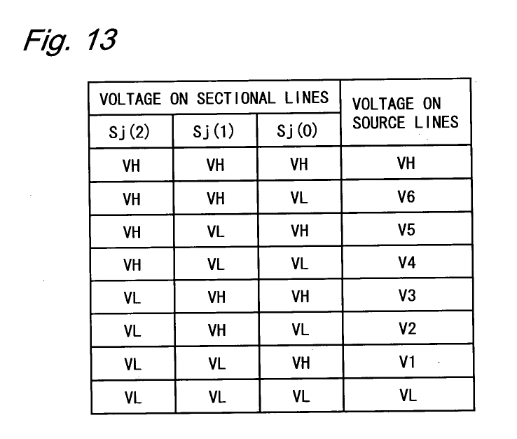

FIGS. 9 to 12 are diagrams illustrating voltage being applied to the sectional lines Sj(2) to Sj(0) or the source lines Sj, respectively, from time points t4 to t5, from time points t5 to t6, from time points t6 to t7, and from time points t7 to t8. The voltage applied to the sectional lines Sj(2) to Sj(0) from time points t4 to t7 and the voltage applied to the source lines Sj from time points t7 to t8 are in the relationship as shown in FIG. 13. In FIGS. 9 to 12, the voltages on the source lines Sj are shown as being VH, V6 to V1, and VL in accordance with the voltage applied to the sectional lines Sj(2) to Sj(0).

In FIG. 8, when the latch pulse LP changes from DH to DL at time point t4, the latch 16 takes in 3-bit data Dj2 to Dj0 to be written to the pixel circuit A1j. From time points t4 to t5, the value of the bit selection signal Sx is 2 and the polarity control signal Rv is DL, so that the selection output Dx of the selection circuit 17 is INV (Dj2) (see FIG. 6). The voltage selection circuit 14 outputs voltage VH when Dj2=1, and voltage VL when Dj2=0. At this time, the control signals E2 to E0 are GH, and therefore TFTs Q2, Q4, and Q6 are turned ON. Accordingly, the output voltage of the voltage selection circuit 14 is applied to the sectional lines Sj(2) to Sj(0). At this time, the voltage of the sectional line Sj(2) is as shown in FIG. 9.

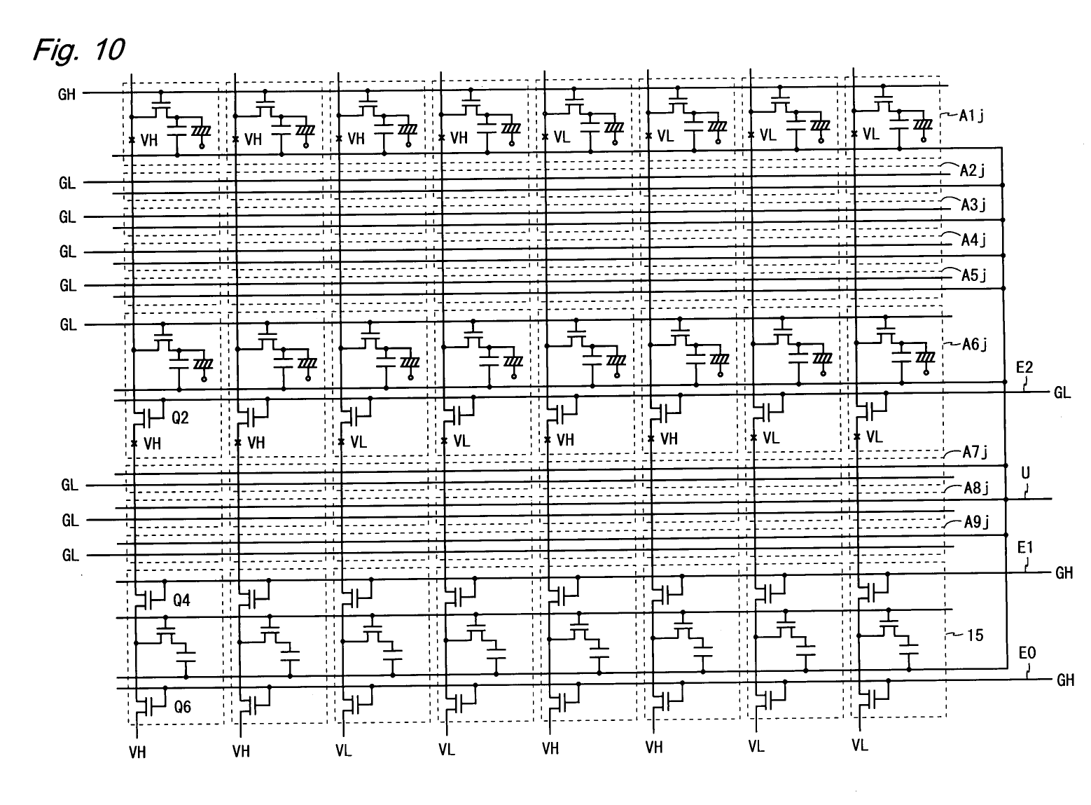

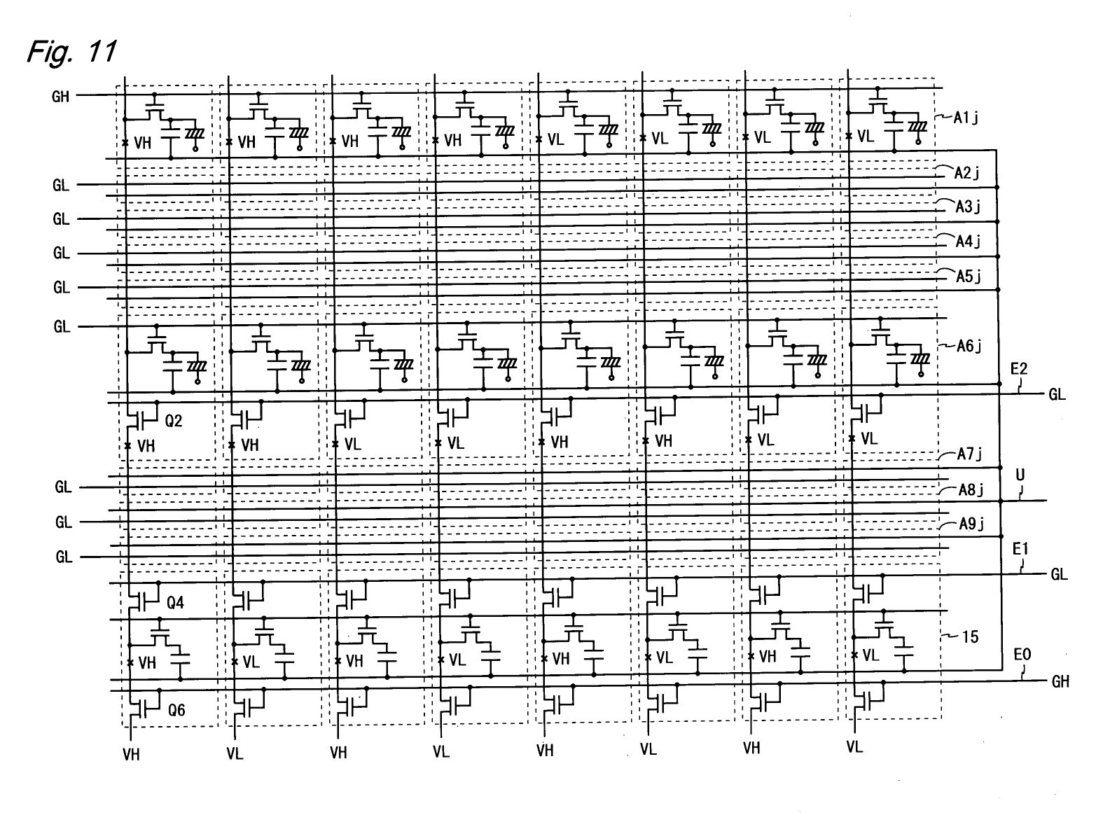

From time points t5 to t6, the value of the bit selection signal Sx is 1 and the polarity control signal Rv is DL, so that the selection output Dx of the selection circuit 17 is INV(Dj1). The voltage selection circuit 14 outputs voltage VH when Dj1=1, and voltage VL when Dj1=0. At this time, the control signals E1 and E0 are GH and the control signal E2 is GL, so that the TFTs Q4 and Q6 are turned ON, and the TFT Q2 is turned OFF. Accordingly, after time point t5, the voltage on the sectional line Sj(2) is maintained at the same level, and the output voltage of the voltage selection circuit 14 is applied to the sectional lines Sj(1) and Sj(0). At this time, the voltage on the sectional lines Sj(2) and Sj(1) is as shown in FIG. 10.

From time points t6 to t7, the value of the bit selection signal Sx is 0 and the polarity control signal Rv is DL, so that the selection output Dx of the selection circuit 17 is INV(Dj0). The voltage selection circuit 14 outputs voltage VH when Dj0=1, and voltage VL when Dj0=0. At this time, the control signal E0 is GH and the control signals E2 and E1 are GL, so that the TFT Q6 is turned ON, and the TFTs Q2 and Q4 are turned OFF. Accordingly, after time point t6, the voltage on the sectional line Sj(1) is maintained at the same level, and the output voltage of the voltage selection circuit 14 is applied to the sectional line Sj(0). At this time, the voltage on the sectional lines Sj(2) to Sj(0) is as shown in FIG. 11.

From time points t7 to t8, the control signals E2 and E1 are GH and the control signal E0 is GL, so that the TFTs Q2 and Q4 are turned ON, and the TFTs Q6 is turned OFF. At this time, the sectional lines Sj(2) to Sj(0) are connected to each other via the TFTs Q2 and Q4, thereby forming a single source line Sj. At this time, the voltage on the source line Sj is equivalent to a weighted average of the voltage applied to the sectional lines Sj(2) to Sj(0) from time points t4 to t7, as will be described below.

The sectional lines Sj(2) to Sj(0) have line capacitances Ca, Cb and Cc, respectively. The sectional line Sj(2) is connected to six pixel circuits, the sectional line Sj(1) is connected to three pixel circuits, and the line capacitance on the sectional line Sj(0) equals to half of the line capacitance on the sectional line Sj(1). Thus, Ca:Cb Cc=6:3:(3/2)=4:2:1.

When the value of the video data is 6, the sectional lines Sj(2) to Sj(0) have respectively voltages VH, VH, and VL applied thereto from time points t4 to t7, so that the voltage on the source line Sj is V6 from time points t7 to t8 (see the second-from-left source lines in FIGS. 9 to 12). Charge accumulated on the sectional lines Sj(2) to Sj(0) does not change before and after time point t7, and therefore the following equation is established.

(Ca+Cb+Cc)V6=Ca·VH+Cb·VH+Cc·VL

Accordingly, voltage V6 is obtained by equation (1). Similarly, voltages V5 to V1 are obtained by equations (2) to (6), respectively.

V6={(Ca+Cb)VH+Cc·VL}/(Ca+Cb+Cc) (1)

V5={(Ca+Cc)VH+Cb·VL}/(Ca+Cb+Cc) (2)

V4={Ca·VH+(Cb+Cc)VL}/(Ca+Cb+Cc) (3)

V3={(Cb+Cc)VH+Ca·VL}/(Ca+Cb+Cc) (4)

V2={Cb·VH+(Ca+Cc)VL}/(Ca+Cb+Cc) (5)

V1={Cc VH+(Ca+Cb)VL}/(Ca+Cb+Cc) (6)

As a result, since Ca:Cb:Cc=4:2:1, for example, if VH=3.5V and VL=0V, then V6=3V, V5=2.5V, V4=2V, V3=1.5V, V2=1V, and V1=0.5V.

In this manner, when the polarity control signal Rv is DL, the voltage on the source line Sj is VH, VH6 to VH1, and VL, respectively, for video data values from 7 to 0. On the other hand, when the polarity control signal Rv is DH, the output voltage of the voltage selection circuit 14 is inverted in polarity, so that the voltage on the source line Sj is VL, VH1 to VH6, and VH, respectively, for video data values from 7 to 0.

From time points t7 to t8, the gate signal G1 is GH, so that the TFT Q1 in the pixel circuit A1j connected to the gate line G1 is turned ON. Accordingly, the voltage on the source line Sj (an average of the voltage applied to the sectional lines) is applied to the pixel electrode P1j in the pixel circuit A1j.

A common electrode driver circuit (not shown) of the display device 1 controls the potential of the common electrode com to be VL when the polarity control signal Rv is DL, and also controls the potential to be VH when the polarity control signal Rv is DH. As a result, when the polarity control signal Rv is DL, a voltage (positive gradation voltage) from 0 to (VH−VL) is applicable to the liquid crystal element Lc, and when the polarity control signal Rv is DH, a voltage (negative gradation voltage) from 0 to (VL−VH) is applicable to the liquid crystal element Lc. Thus, the display device 1 can perform AC drive to alternatingly apply positive and negative gradation voltages to the liquid crystal element Lc, thereby displaying desired video.

Note in FIG. 8, the gate signal G1 is shown as being GH only for a voltage averaging period within one horizontal period (see the solid line waveforms), but in this configuration, influences of charge accumulated in the pixel circuit Aij linger. Therefore, in order to eliminate the influences, the gate signal G1 may be GH during the entire horizontal period (see the broken line waveforms).

In this case, the sectional line Sj(2) is connected to one pixel electrode Pij during one horizontal period for the gate lines G1 to G6, but not connected to any pixel electrode Pij during the reset of the period. Accordingly, the capacitance Ca of the sectional line Sj(2) varies depending on whether the horizontal period is for any of the gate lines G1 to G6. To prevent this variation, a pixel circuit A0j may be disposed outside the pixel circuit A1j, so that voltage on a gate line G0 connected to the pixel circuit A0j is controlled to be GL during one horizontal period for the gate lines G1 to G6, and GH during the rest of the period.

Similarly, the capacitance Cb of the sectional line Sj(1) varies depending on whether the horizontal period is for any of the gate lines G7 to G9. To prevent this variation, a pixel circuit A10j may be disposed between the pixel circuit A9j and the lower-order bit circuit 15, so that a gate line G10 connected to the pixel circuit A10j is controlled to be GL during one horizontal period for the gate lines G7 to G9, and GH during the rest of the period. In this manner, when providing additional pixel circuits for capacitance adjustments, it is necessary to readjust the line capacitances and bit data such that the ratio between the capacitances Ca and Cb is a preferable value.

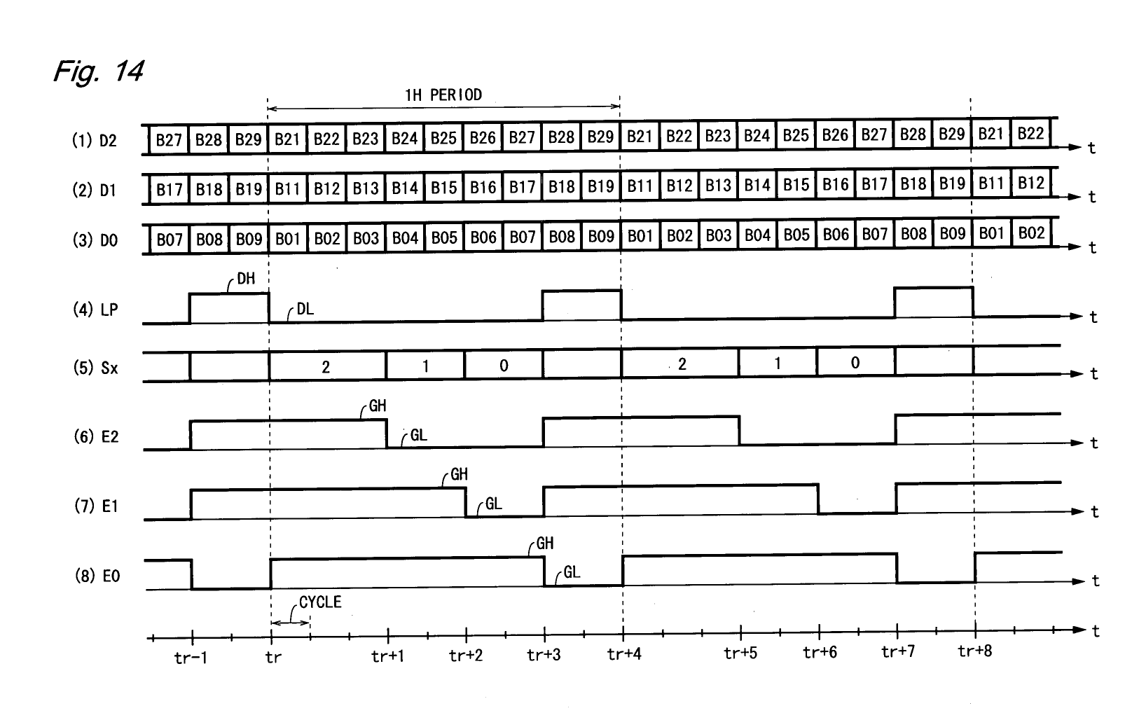

The display device 1 uses a transfer format as shown in FIG. 14 to input video data Din. FIG. 14 is a timing chart illustrating a video data transfer format for the display device 1. In FIG. 14, D2 to D0 each denote video data for one bit, and Bpq (where p is an integer from 0 to 2, and q is an integer from 1 to 9) denotes the p'th bit in the q'th video data. In this example, the number n of pixels in the row direction is 9.

In order to input nine pieces of video data during one horizontal period, one horizontal period is divided into nine cycles, so that a piece of video data is inputted per cycle. The j-th video data is held in a position corresponding to the source line Sj within the register 13. After the ninth video data is inputted, the latch pulse LP changes from DH to DL, and in synchronization with this, (9×3)-bit data held in the register 13 is collectively transferred to 3-bit latches 16 included in nine voltage selection circuits 14. In order to input video data Din using the transfer format shown in FIG. 14, the source driver circuit 11 includes an (n×3)-bit register 13 and n voltage selection circuits 14 each having a 3-bit latch.

As described above, the display device 1 according to the present embodiment includes a plurality of gate lines G1, a plurality of source lines Sj, a plurality of pixel circuits Aij disposed at corresponding intersections of the gate lines G1 and the source lines Sj, a plurality of sectional lines Sj(2) to Sj(0) functioning as capacitances, which are formed by dividing their respective source lines Sj, first switching elements (TFTs Q6) provided between the capacitances and lines with a fixed potential VH or VL, and second switching elements (TFTs Q2 and Q4) provided between the capacitances.

During the voltage application period, the first switching element is turned ON, and the second switching elements start with both TFTs being turned ON, then with only the TFT Q4 being in ON, and finally with both of them being in OFF state, so that voltage VH or VL is applied to the sectional lines Sj(2) to Sj(0) in accordance with bits in the video data. During the voltage averaging period, the first switching element is turned OFF and the second switching elements are turned ON, so that the voltage on the source line Sj is equivalent to an average of the voltage applied to the sectional lines Sj(2) to Sj(0) The averaged voltage is applied to the pixel electrode Pij in the pixel circuit Aij including an active element (TFT Q1) in ON state. There are eight patterns of voltage to be applied to the sectional lines Sj(2) to Sj(0), and therefore eight types of gradation voltage can be generated by averaging each pattern.

Accordingly, the display device 1 according to the present embodiment makes it possible to generate gradation voltage in accordance with video data and apply the generated voltage to the pixel electrodes Pij, thereby displaying desired video, without using operational amplifier circuits (and buffer circuits). In addition, since operational amplifier circuits (and buffer circuits) are not used, it is possible to eliminate current constantly flowing between power sources of operational amplifier circuits (and buffer circuits), thereby reducing power consumption of the display device.

In the case of the display device 1, the sectional line Sj(1) and the sectional line Sj(0) are charged twice and thrice, respectively, during one horizontal period, and therefore current flowing through the source line Sj is large compared to conventional display devices. However, in general, current flowing between power sources of operational amplifier circuits is larger by about one digit than the current flowing through the source line Sj. Accordingly, even if the current flowing through the source line Sj is larger than conventional, much larger current flowing between power sources of operational amplifier circuits is eliminated, making it possible to reduce more power consumption than conventional. To reduce the current flowing through the source line Sj, the display device 1 is configured such that the sectional line Sj(2), which has the largest line capacitance, is charged only once.

Also, the gradation voltage generated in the display device 1 is dependent on voltage held in the capacitances, as well as in floating capacitances between the source lines, but is not dependent on characteristics (threshold and mobility) of the switching elements. Therefore, even when the switching elements are formed using CG silicon or polysilicon TFTs whose characteristics, such as threshold and mobility, tend to vary therebetween, variation of the gradation voltage is small. Thus, even when CG silicon or polysilicon TFTs are used, driver-monolithic display devices can be realized at high yield and at low cost.

Also, in the case of the display device 1, the source line Sj is divided, forming three sectional lines Sj(2) to Sj(0) functioning as capacitances. In this manner, by dividing the source line Sj to form all or part of the capacitances, it becomes possible to reduce the area in which the capacitances are formed. Furthermore, in the display device 1, the sectional lines Sj(2) and Sj(1) are disposed inside the display area 10, the sectional line Sj(0) is disposed outside the display area 10, and the relationship Ca:Cb:Cc=4:2:1 is established as described above. Accordingly, the capacitance Cc provided outside the display area 10 may be ⅙ of the line capacitance (Ca+Cb) on the source line Sj.

Also, in the display device 1, only two of the sectional lines Sj(2) to Sj(0), i.e., the sectional lines Sj(2) and Sj(1) are disposed inside the display area 10, and therefore, for each data signal line Sj, only one second switching element may be provided and disposed inside the display area 10. Furthermore, the distance between the control line E2 for the second switching element (TFT Q2) disposed inside the display area 10 and its adjacent gate lines G6 and G7 is approximately equal to the distance between the gate lines G1 to G6 and between the gate lines G7 to G9. Accordingly, by replacing only one of the gate lines G1 with the control line E2, the presence of the control line E2 can be rendered less conspicuous among the gate lines G1 from the perspective of arrangement intervals. Furthermore, only one gate line is lacking due to replacement, and therefore an adjacent gate line may be used in place of the lacking gate line.

While the display device 1 has been described with respect to the case where the number of bits in video data is three, the number of bits in video data may be arbitrary. For example, in order to deal with 4-bit video data, an additional capacitance which equals to half of the capacitance on the sectional line Sj(0) may be provided to the display device 1. Similarly, by further providing additional half-sized capacitances, it becomes possible to deal with video data with even 5 bits or more.

In general, a line capacitance on a source line corresponding to one pixel circuit is equivalent to about a few percent of the capacitance which can be formed in the same size as the pixel circuit. Accordingly, an area equivalent in size to several pixel circuits is amply sufficient to form a capacitance equivalent to the total capacitance of the source lines outside the display area. Also, a plurality of sectional lines formed by dividing the source line Sj can be freely arranged either inside or outside the display area or both.

Also, while the display device 1 has been described as including two fixed-potential lines, three or more fixed-potential lines may be provided. For example, in the case of a display device including four fixed-potential lines, a voltage selection circuit outputs four types of voltage in accordance with two bits in each piece of video data. The display devices according to these variants also achieve effects similar to those achieved by the display device 1.

### Second Embodiment

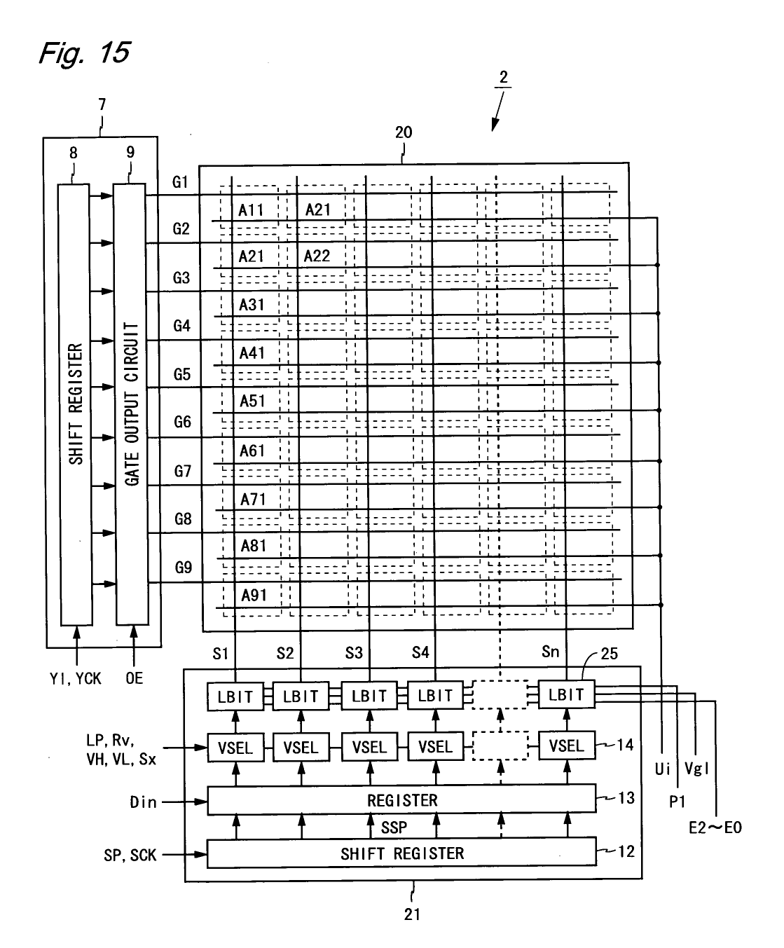

FIG. 15 is a block diagram illustrating the configuration of a display device according to a second embodiment of the present invention. The display device 2 shown in FIG. 15 includes a display area 20, a gate driver circuit 7, and a source driver circuit 21. In each embodiment described below, the same elements as in any of the preceding embodiments are denoted by the same reference characters, and any descriptions thereof will be omitted.

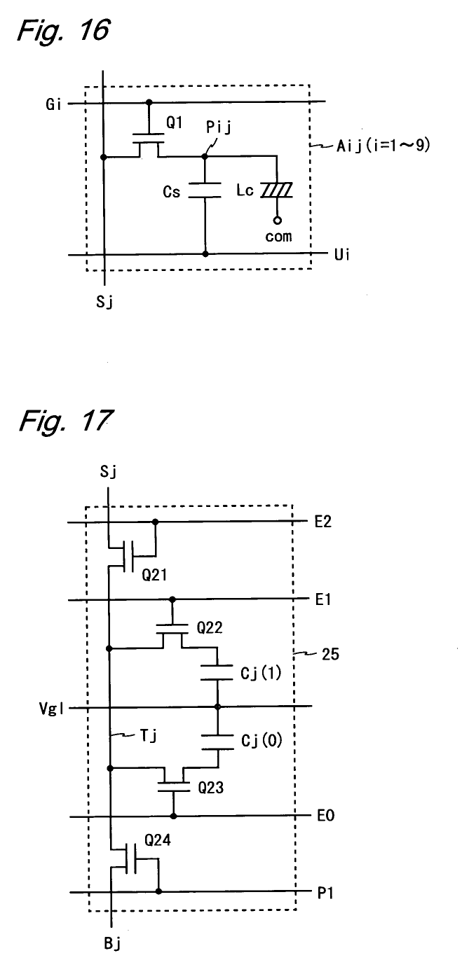

As in the first embodiment, the display area 20 is provided with m gate lines Gi (in FIG. 15, m=9), n source lines Sj, and (m×n) pixel circuits Aij. However, the source lines Sj are not divided into sectional lines, and each pixel circuit Aij has a circuit configuration as shown in FIG. 16. The pixel circuit shown in FIG. 16 is the same as the pixel circuit shown in FIG. 2 except that the source terminal of the TFT Q1 is connected to the source line Sj.

The source driver circuit 21 includes a lower-order bit circuit 25 in place of the lower-order bit circuit 15 in the source driver circuit 11 according to the first embodiment. FIG. 17 is an equivalent circuit diagram for the lower-order bit circuit 25. The lower-order bit circuit 25 is provided with two capacitors Cj(1) and Cj(0). A TFT Q21 is disposed between the source line Sj and a node Tj, a TFT Q22 is disposed between the capacitor Cj(1) and the node Tj, a TFT Q23 is disposed between the capacitor Cj(0) and the node Tj, and a TFT Q24 is disposed between an input terminal Bj and the node Tj. The TFT Q24 functions as a first switching element, and the TFTs Q21 to Q23 function as second switching elements. The TFTs Q21 to Q24 are n-type TFTs, and the TFTs Q21 to Q24 have their gate terminals connected to control lines E2 to E0 and P1, respectively.

The capacitor Cj(1) is configured so as to have half of the line capacitance on the source line Sj, and the capacitor Cj(0) is configured so as to have half of the capacitance of the capacitor Cj(1). In the display device 2, the source line Sj corresponds to the second bit in video data, and the capacitors Cj(1) and Cj(0) correspond to the first and zeroth bits, respectively, in video data.

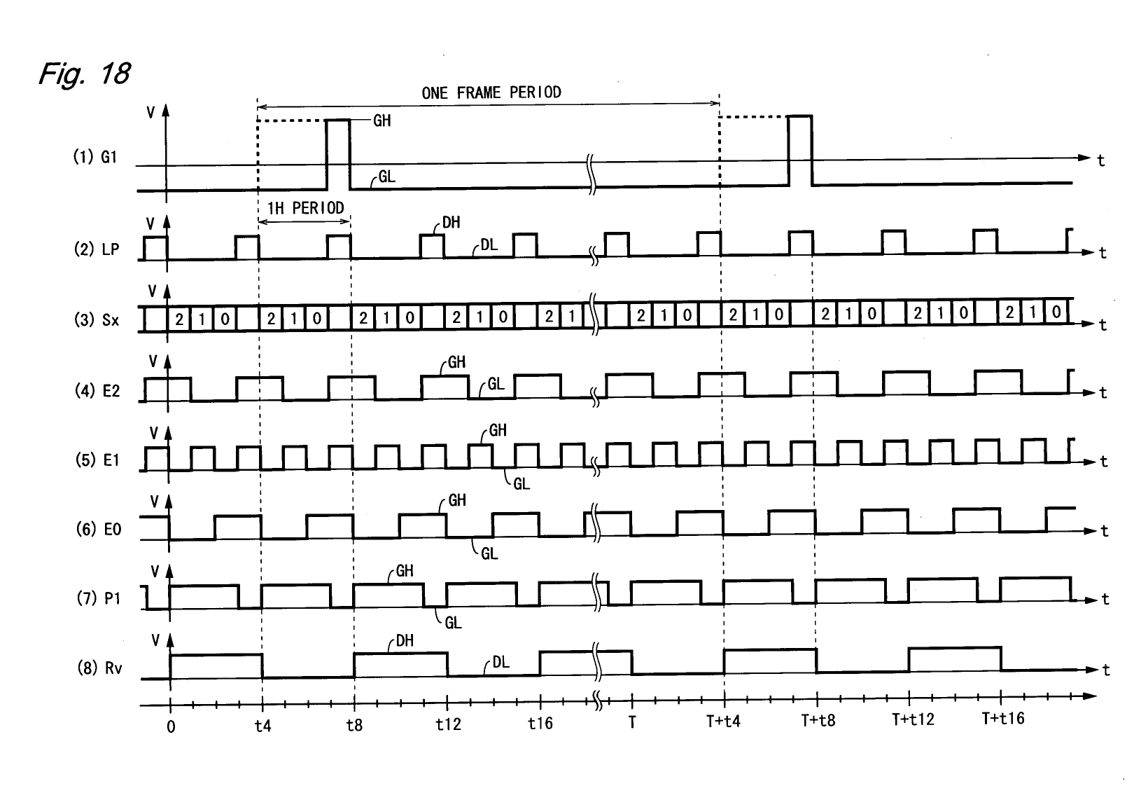

FIG. 18 is a timing chart for the display device 2. FIG. 18 shows changes of a gate signal G1 in (1), a latch pulse LP in (2), a bit selection signal Sx in (3), control signals E2 to E0 in (4) to (6), respectively, a control signal P1 in (7) and a polarity control signal Rv in (8).

Referring to FIG. 18, the operation of the display device 2 during one horizontal period (time points t4 to t8) for the gate line G1 will be described. One horizontal period is divided into a voltage application period (time points t4 to t7) and a voltage averaging period (time points t7 to t8). The gate signal G1, the latch pulse LP, the bit selection signal Sx, the control signal E2, and the polarity control signal Rv change in the same manner as in FIG. 8. The control signal E1 is GL from time points t4 to t5 and from time points t6 to t7, and GH for the rest of the period. The control signal E0 is GL from time points t4 to t6, and GH for the rest of the period. The control signal P1 is GL from time points t7 to t8, and GH for the rest of the period. Generally, in each horizontal period, the control signals E1, E0, and P1 change in the same manner as they do from time points t4 to t8.

Similar to FIG. 8, the voltage selection circuit 14 outputs voltage corresponding to data Dj2 (the second bit in video data) from time points t4 to t5, voltage corresponding to data Dj1 (the first bit in video data) from time points t5 to t6, and voltage corresponding to data Dj0 (the zeroth bit in video data) from time points t6 to t7.

From time points t4 to t5, the control signals E2 and P1 are GH and the control signals E1 and E0 are GL, so that the TFTs Q21 and Q24 are turned ON, and the TFTs Q22 and Q23 are turned OFF. Accordingly, output voltage of the voltage selection circuit 14 is applied to the source line Sj, and charge corresponding to data Dj2 accumulates on the source line Sj.

From time points t5 to t6, the control signals E1 and P1 are GH and the control signals E2 and E0 are GL, so that the TFTs Q22 and Q24 are turned ON, and the TFTs Q21 and Q23 are turned OFF. Accordingly, output voltage of the voltage selection circuit 14 is applied to the capacitor Cj(1), and charge corresponding to data Dj1 accumulates on the capacitor Cj(1).

From time points t6 to t7, the control signals E0 and P1 are GH and the control signals E2 and E1 are GL, so that the TFTs Q23 and Q24 are turned ON, and the TFTs Q21 and Q22 are turned OFF. Accordingly, output voltage of the voltage selection circuit 14 is applied to the capacitor Cj(0), and charge corresponding to data Dj0 accumulates on the capacitor Cj(0).

From time points t7 to t8, the control signals E2 to E0 are GH and the control signal P1 is GL, so that the TFTs Q21 to Q23 are turned ON, and the TFT Q24 is turned OFF. At this time, the source line S1 and the capacitors Cj(1) and Cj(0) are mutually connected via the TFTs Q21 to Q23. The voltage of the source line Sj at this time is equivalent to a weighted average of the voltage applied to the source line Sj and the capacitors Cj(1) and Cj(0) from time points t4 to t7. From time points t7 to t8, the gate signal G1 is GH, and therefore the voltage on the source line Sj is applied to the pixel electrode P1j in the pixel circuit A1j.

As in the first embodiment, the potential of the common electrode com is controlled to be VL when the polarity control signal Rv is DL, and VH when the polarity control signal Rv is DH. As a result, when the polarity control signal Rv is DL, a voltage (positive gradation voltage) from 0 to (VH−VL) is applicable to the liquid crystal element Lc, and when the polarity control signal Rv is DH, a voltage (negative gradation voltage) from (VL−VH) to 0 is applicable to the liquid crystal element Lc.

In this manner, in the case of the display device 2 according to the present embodiment, the first switching element (TFT Q24) and any of the second switching elements (TFTs Q21 to Q23) are turned ON during the voltage application period, so that voltage corresponding to bits in video data is applied to the source line Sj and the capacitors Cj(1) and Cj(0). During the voltage averaging period, the first switching element is turned OFF and the second switching elements are turned ON, so that the voltage on the source line Sj is equivalent to an average of the voltage applied to the source line Sj and the capacitors Cj(1) and Cj(0). The averaged voltage is applied to the pixel electrode Pij in the pixel circuit Aij including an active element (TFT Q1) in ON state.

Accordingly, as with the display device 1 according to the first embodiment, the display device 2 according to the present embodiment makes it possible to generate gradation voltage according with video data and apply the generated voltage to the pixel electrodes Pij, thereby displaying desired video, without using operational amplifier circuits (and buffer circuits). In addition, since operational amplifier circuits (and buffer circuits) are not used, it is possible to eliminate current constantly flowing between power sources of operational amplifier circuits, thereby reducing power consumption of the display device, and realizing driver-monolithic display devices at high yield and at low cost.

### Third Embodiment

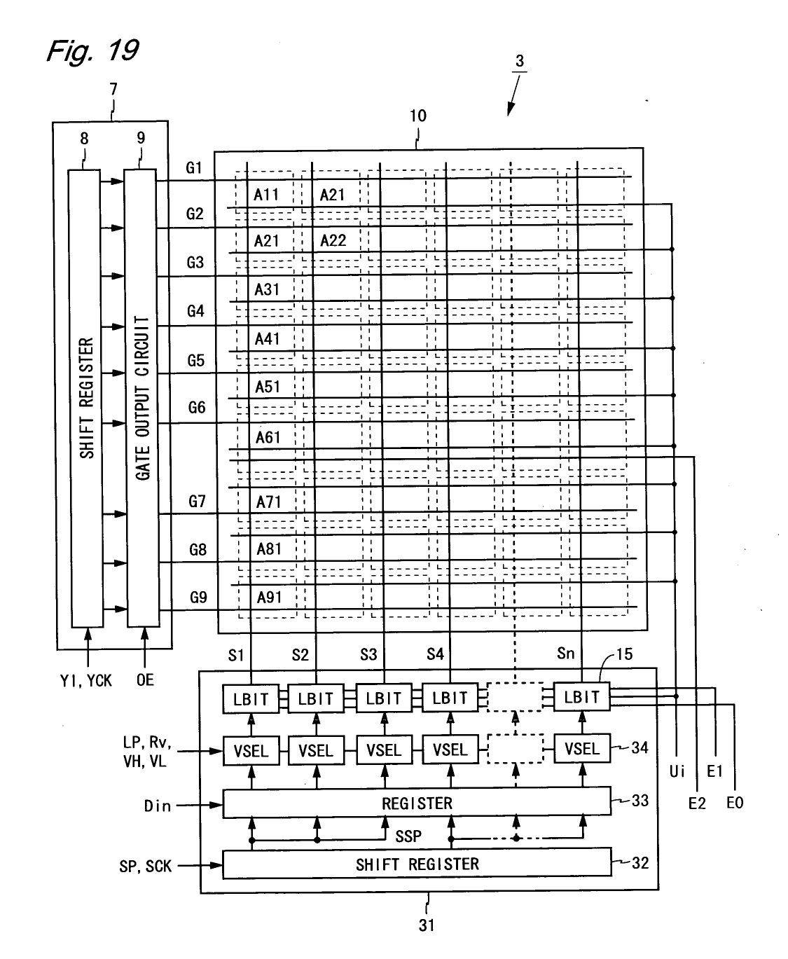

FIG. 19 is a block diagram illustrating the configuration of a display device according to a third embodiment of the present invention. The display device 3 shown in FIG. 19 includes a source driver circuit 31 in place of the source driver circuit 11 in the display device 1 according to the first embodiment. The display device 3 is characterized by inputting video data Din using a format in which equally weighted portions are collected from plural pieces of numerical data and sequentially transferred.

As described in the first embodiment, voltage corresponding to the second bit in video data is initially applied during the voltage application period, then voltage corresponding to the first bit in video data is applied, and finally voltage corresponding to the zeroth bit in video data is applied. Accordingly, by collecting and inputting initially the second bits in video data, then the first bits in video data, and finally the zeroth bits in video data, rather than by sequentially inputting video data piece by piece, it becomes possible to reduce the circuit complexity of the source driver circuit 31.

The source driver circuit 31 includes an (n/3)-bit shift register 32, an n-bit register 33, n voltage selection circuits 34 each having a 1-bit latch, and n lower-order bit circuits 15. The shift register 32 sequentially transfers a start pulse SP in accordance with a clock SCK. Outputs from the shift register 32 are provided to the register 33 as timing pulses SSP. When the a'th (where a is an integer from 1 to (n/3)) timing pulse SSP is outputted, the register 33 holds 3-bit video data Din bit by bit in positions corresponding to source lines Sb-2, Sb-1, and Sb (where b=3a).

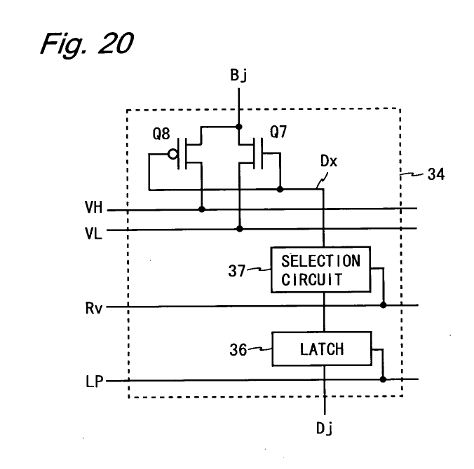

FIG. 20 is a block diagram illustrating the voltage selection circuit 34 in detail. In FIG. 20, a latch 36 is a 1-bit latch for taking in, in accordance with a latch pulse LP, 1-bit data Dj held in the register 33. The selection circuit 37 outputs the 1-bit data held in the latch 36 with a polarity corresponding to a polarity control signal Rv. A selection output Dx of the selection circuit 37 is Dj when the polarity control signal Rv is DL, and INV(Dj) when the polarity control signal Rv is DH.

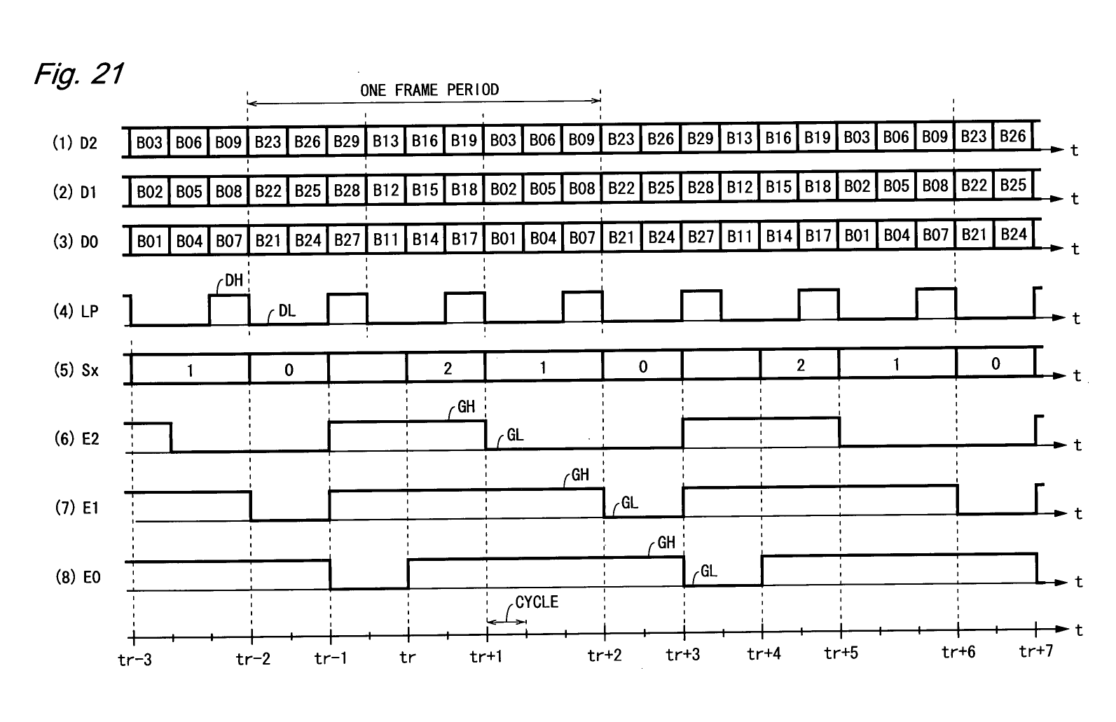

FIG. 21 is a timing chart illustrating a video data transfer format for the display device 3. In this example, the number n of pixels in the row direction is nine. To input nine pieces of video data during one horizontal period, one horizontal period is divided into nine cycles, and video data for 3 bits is inputted per cycle. Initially, the second bits B2q (nine bits in total; the same shall apply below) in video data are collected, and inputted three bits at a time in three cycles. Then, the first bits B1q in video data are collected, and inputted three bits at a time in three cycles. Lastly, the zeroth bits B0q in video data are collected, and inputted three bits at a time in three cycles. The latch pulse LP changes from DH to DL every third cycle.

To input video data Din using the transfer format shown in FIG. 21, the source driver circuit 31 includes an (n/3)-bit shift register 32, an n-bit register 33, and n voltage selection circuits 34 each having a 1-bit latch. Also, no bit selection signal Sx is needed. Accordingly, the circuit complexity of the source driver circuit 31 is lower than that of the source driver circuit 11 according to the first embodiment.

As described above, the display device 3 according to the present embodiment uses a format for inputting video data, in which equally weighted portions are collected from plural pieces of numerical data and sequentially transferred, making it possible to reduce the complexity of the source driver circuit and thereby to realize display devices at high yield and at low cost.

### Fourth Embodiment

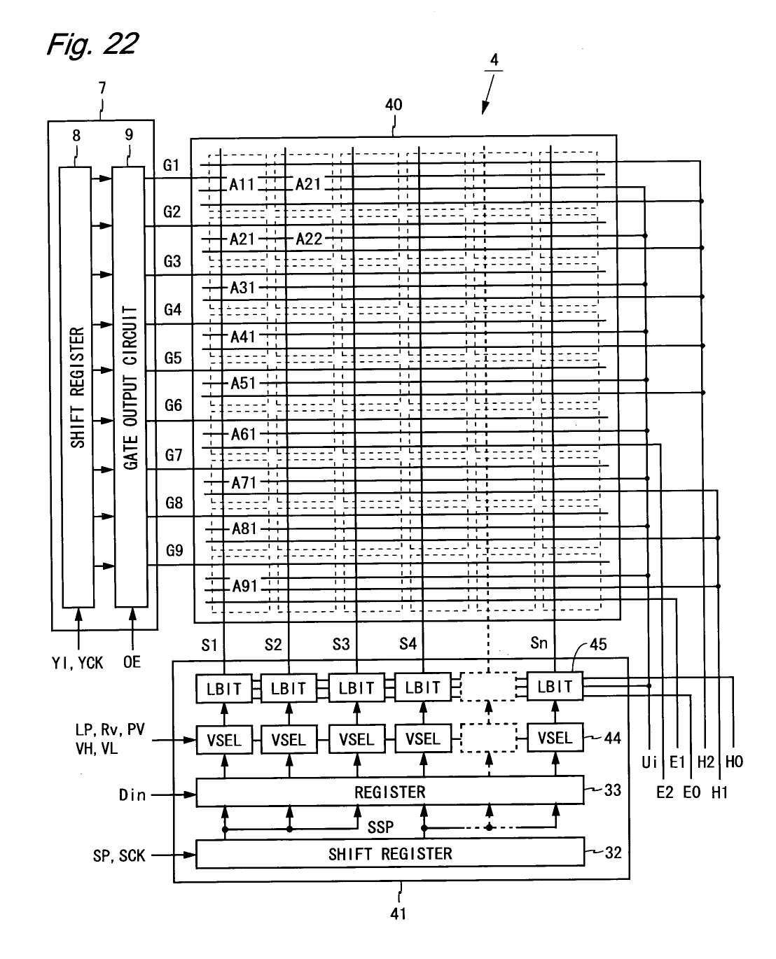

FIG. 22 is a block diagram illustrating the configuration of a display device according to a fourth embodiment of the present invention. The display device 4 shown in FIG. 22 includes a display area 40, a gate driver circuit 7, and a source driver circuit 41.

As in the first embodiment, the display area 40 is provided with m gate lines Gi (in FIG. 22, m=9), n source lines Sj, and (m×n) pixel circuits Aij. The source lines Sj are each divided into three sectional lines Sj(2) to Sj(0) in accordance with the number of bits (3 bits) in video data.

The display device 4 is provided with a plurality of capacitance lines H2 to H0 crossing the source lines Sj so as to be in parallel to the gate lines G1. The capacitance lines H2 and H1 are provided inside the display area 40, and the capacitance line H0 is provided outside the display area 40. Capacitors are formed at intersections of the source lines Sj and the capacitance lines H2 to H0.

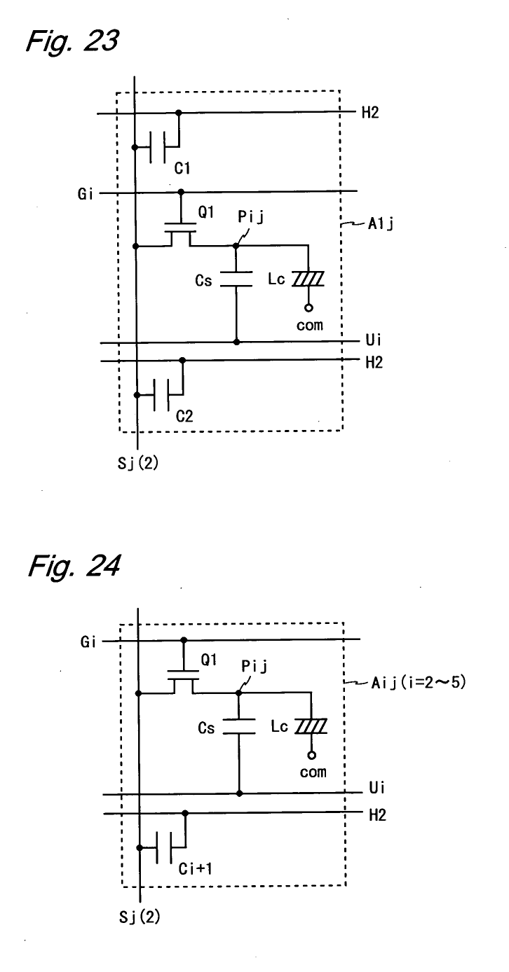

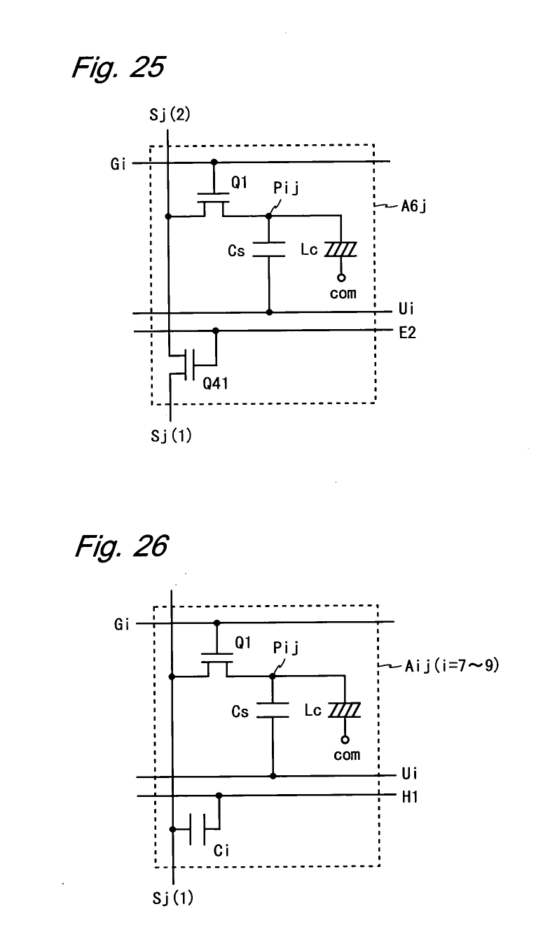

The pixel circuits Aij vary in circuit configuration in accordance with the row number i. In the display device 4, the pixel circuit A1j has a circuit configuration as shown in FIG. 23, the pixel circuits A2j to A5j have a circuit configuration as shown in FIG. 24, the pixel circuit A6j has a circuit configuration as shown in FIG. 25, and the pixel circuits A7j to A9j have a circuit configuration as shown in FIG. 26. The pixel circuit shown in FIG. 23 is a pixel circuit as shown in FIG. 2 to which two capacitors C1 and C2 are added. The capacitors C1 and C2 are formed by the sectional line Sj(2) crossing the capacitance line H2. The pixel circuit shown in FIG. 24 is a pixel circuit as shown in FIG. 2 to which a capacitor Ci+1 is added. The capacitor Ci+1 is formed by the sectional line Sj(2) crossing the capacitance line H2.

The pixel circuit shown in FIG. 25 is a pixel circuit as shown in FIG. 2 to which a TFT Q41 is added as a second switching element. The TFT Q41 is an n-type TFT disposed between the sectional lines Sj(2) and Sj(1). The TFT Q41 has a gate terminal connected to the control line E2. The pixel circuit shown in FIG. 26 is a pixel circuit as shown in FIG. 2 to which a capacitor Ci is added with the source terminal of the TFT Q1 being connected to the sectional line Sj(1). The capacitor Ci is formed by the sectional line Sj(1) crossing the capacitance line H1.

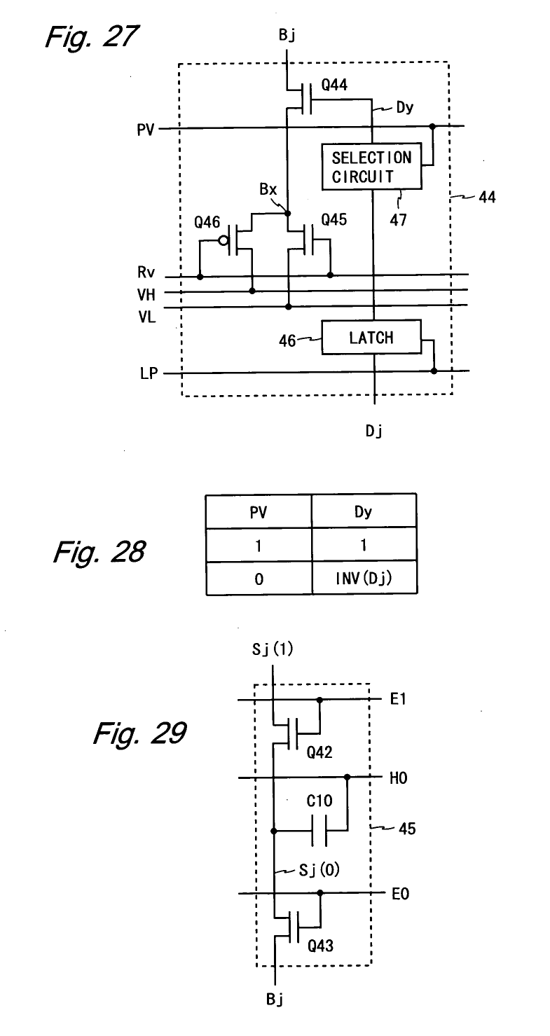

The source driver circuit 41 includes an (n/3)-bit shift register 32, an n-bit register 33, n voltage selection circuits 44 each having a 1-bit latch, and n lower-order bit circuits 45. FIG. 27 is a block diagram illustrating the voltage selection circuit 44 in detail. In FIG. 27, a latch 46 is a 1-bit latch for taking in, in accordance with a latch pulse LP, 1-bit data Dj held in the register 33. A selection circuit 47 performs a logical operation between the 1-bit data held in the latch 46 and a control signal PV. A selection output Dy of the selection circuit 47 is determined based on the control signal PV and the data Dj, as shown in FIG. 28.

In the voltage selection circuit 44, TFTs Q44 and Q45 are disposed in series between an output terminal Bj and a line with a fixed potential VL, and a TFT Q46 is disposed between a connecting point Bx of the TFTs Q44 and Q45 and a line with a fixed potential VH. The TFTs Q44 and Q45 are n-type TFTs, and the TFT Q46 is a p-type TFT. The TFT Q44 has the selection output Dy applied to its gate terminal, and the TFTs Q45 and Q46 have a polarity control signal Rv applied to their gate terminals. When the selection output Dy is 1 and the polarity control signal Rv is DH, voltage VL is outputted from the output terminal Bj; when the selection output Dy is 1 and the polarity control signal Rv is DL, voltage VH is outputted from the output terminal Bj; when the selection output Dx is 0, the output terminal Bj is in open state.

FIG. 29 is an equivalent circuit diagram for the lower-order bit circuit 45. The lower-order bit circuit 45 is provided with the sectional line Sj(0) and a capacitor C10. A TFT Q43, which is a first switching element, is disposed between an input terminal Bj of the lower-order bit circuit 45 and the sectional line Sj(0), and a TFT Q42, which is a second switching element, is disposed between the sectional lines Sj(0) and Sj(1). The capacitor C10 is formed by the sectional line Sj(0) crossing the capacitance line H0. The TFTs Q42 and Q43 are n-type TFTs, and have their gate terminals connected to control lines E1 and E0, respectively.

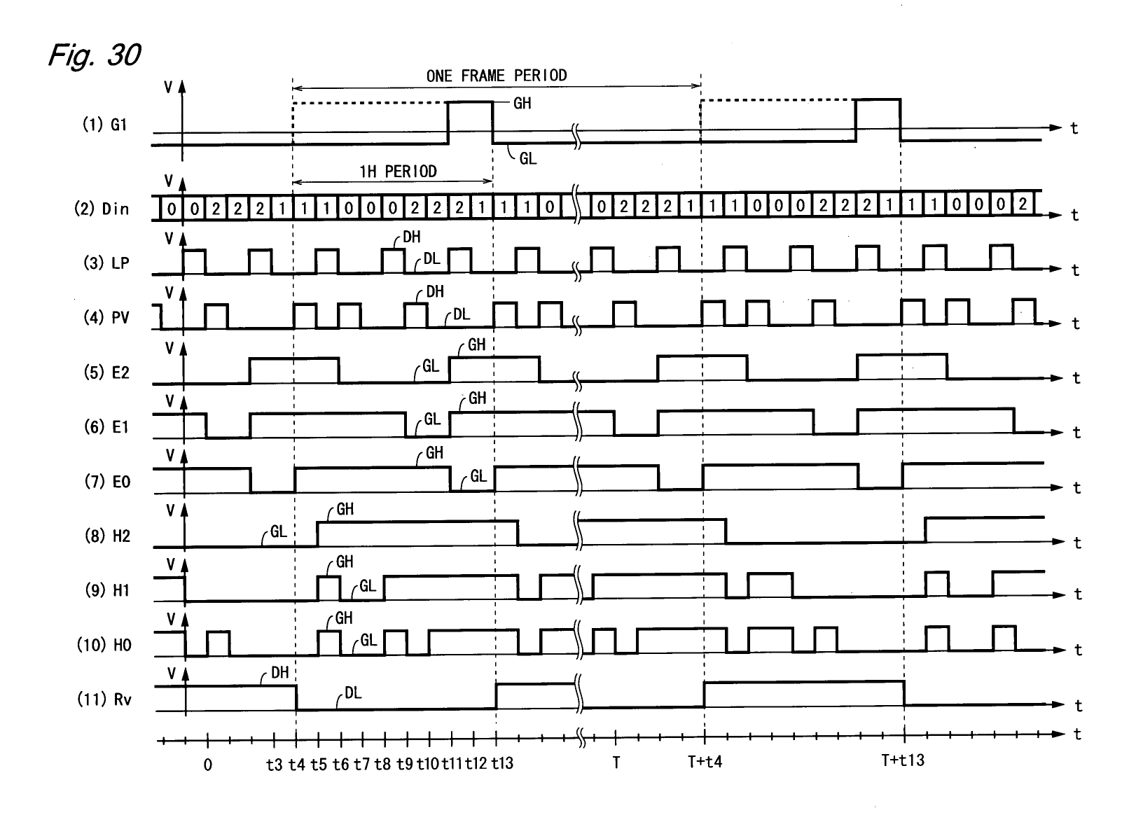

FIG. 30 is a timing chart for the display device 4. Hereinafter, a signal on a capacitance line is referred to as a “capacitance control signal”. FIG. 30 shows changes of a gate signal G1 in (1), video data Din in (2), a latch pulse LP in (3), a control signal PV in (4), control signals E2 to E0 in (5) to (7), respectively, capacitance control signals H2 to H0 in (8) to (10), respectively, and a polarity control signal Rv in (11). In FIG. 30, tk denotes a time point after a lapse of k sub-periods from time point 0 within one horizontal period divided into nine sub-periods.

Referring to FIGS. 30 to 38, the operation of the display device 4 during one horizontal period (time points t4 to t13) for the gate line G1 will be described. One horizontal period is divided into a voltage application period (time points t4 to t11) and a voltage averaging period (time points t11 to t13). The gate signal G1 is GH from time points t11 to t13, and GL for the rest of the period. The latch pulse LP is DH from time points t5 to t6, from time points t8 to t9, and from time points t11 to t12, and DL for the rest of the period. The control signal PV is DH from time points t4 to t5, from time points t6 to t7, and from time points t9 to t10, and DL for the rest of the period. The control signal E2 is GL from time points t6 to t11, and GH for the rest of the period. The control signal E1 is GL from time points t9 to t11, and GH for the rest of the period. The control signal E0 is GL from time points t11 to t13, and GH for the rest of the period. The capacitance control signal H2 is GL from time points t4 to t5, and GH for the rest of the period. The capacitance control signal H1 is GL from time points t4 to t5 and from time points t6 to t8, and GH for the rest of the period. The capacitance control signal H0 is DL from time points t4 to t5, from time points t6 to t8, and from time points t9 to t10, and DH for the rest of the period. The polarity control signal Rv is DL from time points t4 to t13.

Generally, in each frame period, the gate signal G1 is GH during a portion of a certain horizontal period, and GL for the rest of the period. In each horizontal period, the latch pulse LP, and the control signals PV and E2 to E0 change in the same manner as they do from time points t4 to t13. The polarity control signal Rv changes between DH and DL every horizontal period, and the polarity thereof is inverted in the next frame period. The capacitance control signals H2 to H0 change as described above when the polarity control signal Rv is DL, and they are inverted in polarity when the polarity control signal Rv is DH.

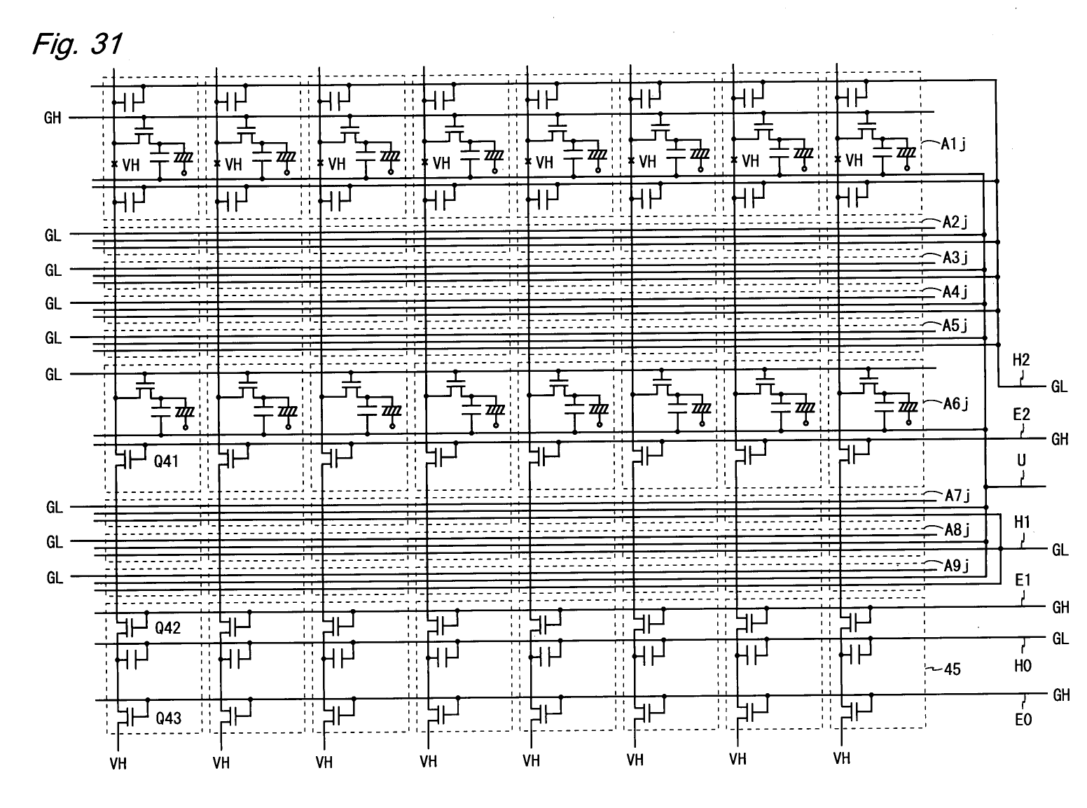

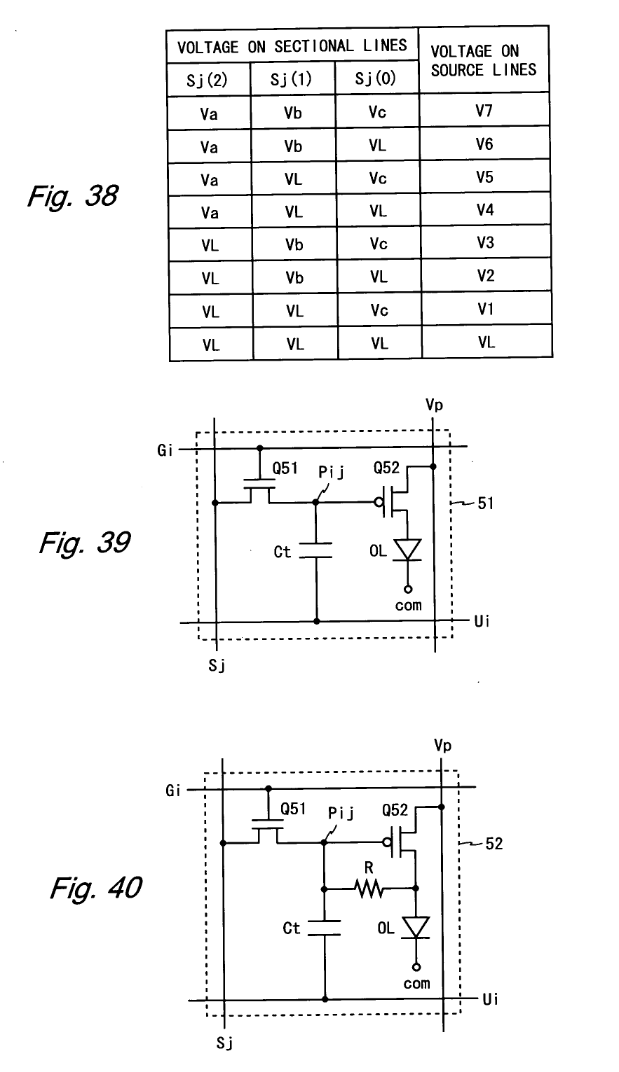

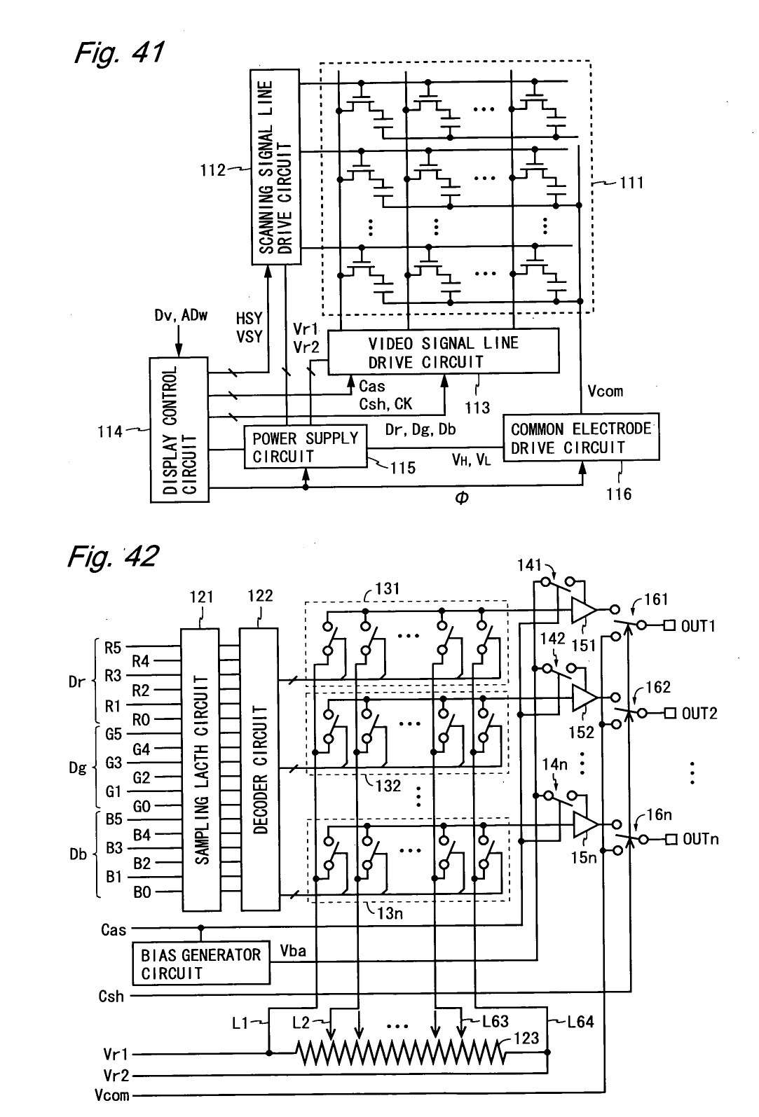

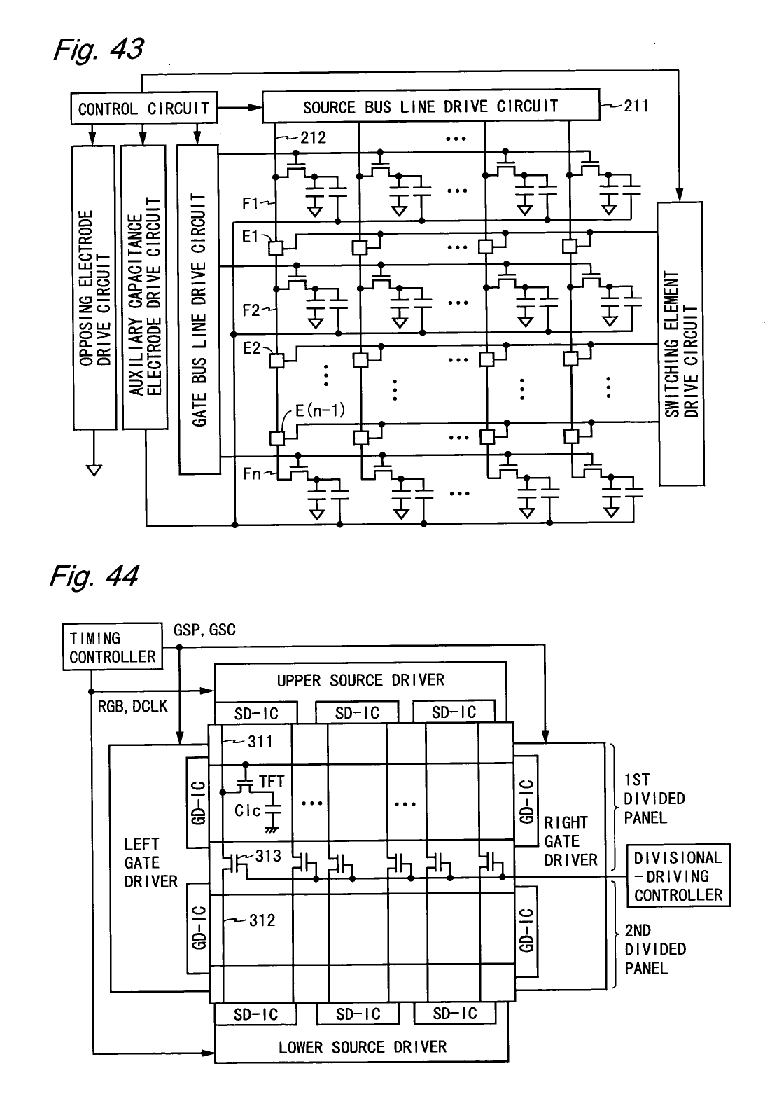

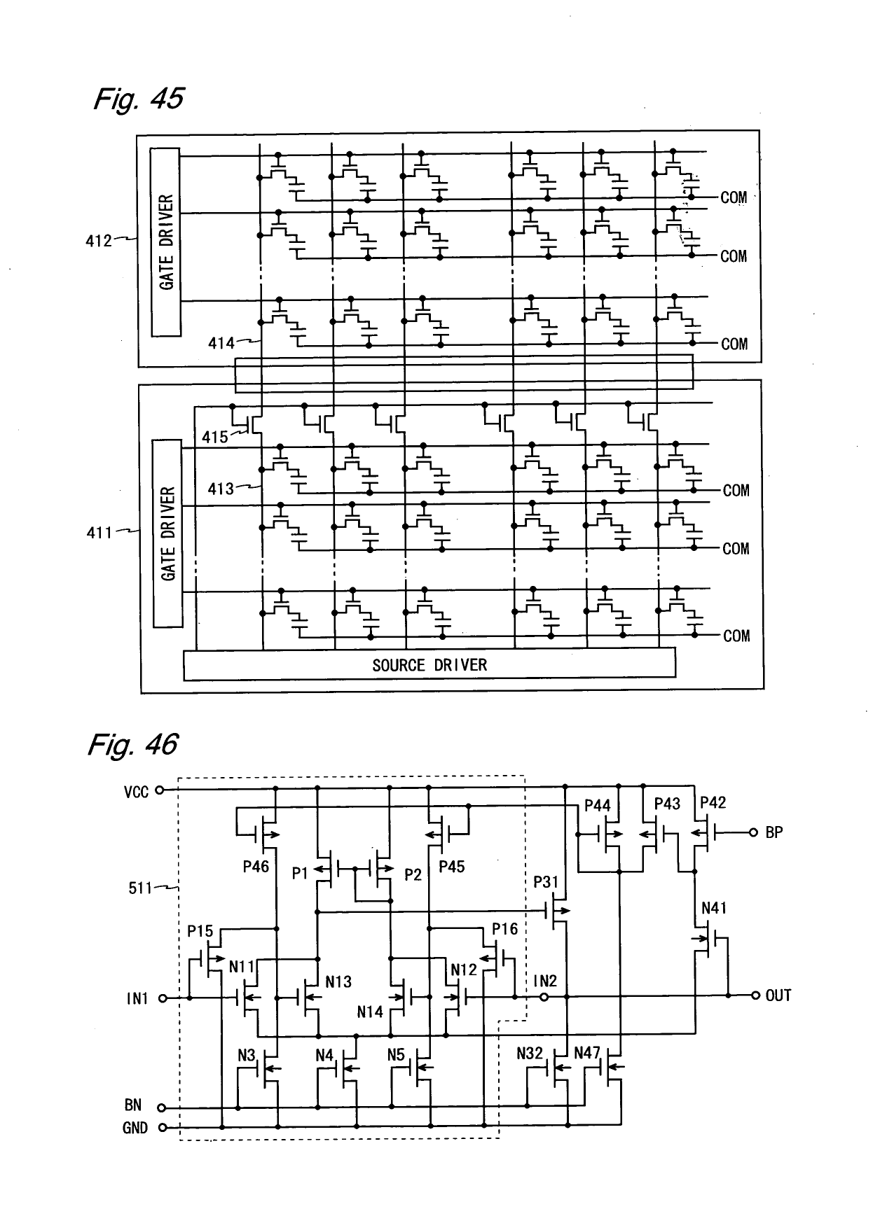

FIGS. 31 to 37 are diagrams illustrating voltage being applied to the sectional lines Sj(2) to Sj(0) or the source lines Sj, respectively, from time points t4 to t5, from time points t5 to t6, from time points t6 to t8, from time points t8 to t9, from time points t9 to t10, from time points t10 to t11, and from time points t11 to t13. The voltage applied to the sectional lines Sj(2) to Sj(0) from time points t4 to t11 and the voltage applied to the source lines Sj from time points t11 to t13 are in the relationship as shown in FIG. 38. In FIGS. 31 to 37, the voltages on the source lines Sj are shown as being V7 to V1 and VH in accordance with the voltage applied to the sectional lines Sj(2) to Sj(0).

The display device 4 inputs video data Din using a transfer format as shown in FIG. 21. In FIG. 30, three of nine second bits in video data are inputted during sub-periods denoted by “2” for Din. Similarly, three of nine first bits in video data are inputted during sub-periods denoted by “1” for Din, and three of nine zeroth bits in video data are inputted during sub-periods denoted by “0” for Din.

Video data to be written to the pixel circuit A1j is inputted from time points 0 to t9. From time points 0 to t3, nine second bits in video data are inputted, and when the latch pulse LP changes from DH to DL at time point t3, the second bits in video data are held in the latch 46. From time points t3 to t6, nine first bits in video data are inputted, and when the latch pulse LP changes from DH to DL at time point t6, the first bits in video data are held in the latch 46. From time points t6 to t9, nine zeroth bits in video data are inputted, and when the latch pulse LP changes from DH to DL at time point t9, the zeroth bits in video data are held in the latch 46. Hereinafter, the second to zeroth bits in the video data held in the latch 46 are denoted by Xj2 to Xj0, respectively.

From time points t4 to t13, the polarity control signal Rv is DL, so that the TFT Q45 is turned OFF, and the TFT Q46 is turned ON. Accordingly, when the selection output Dy is 1, the voltage selection circuit 44 outputs voltage VH, and when the selection output Dy is 0, the output terminal Bj of the voltage selection circuit 44 is in open state.

From time points t4 to t5, the control signal PV is DH, so that the selection output Dy is 1 (see FIG. 28), and the voltage selection circuit 44 outputs voltage VH. At this time, the control signals E2 to E0 are DH, and therefore the TFTs Q41, Q42, and Q43 are turned ON. Accordingly, the output voltage VH of the voltage selection circuit 44 is applied to the sectional lines Sj(2) to Sj(0). At this time, the capacitance control signals H2 to H0 are GL (see FIG. 31).

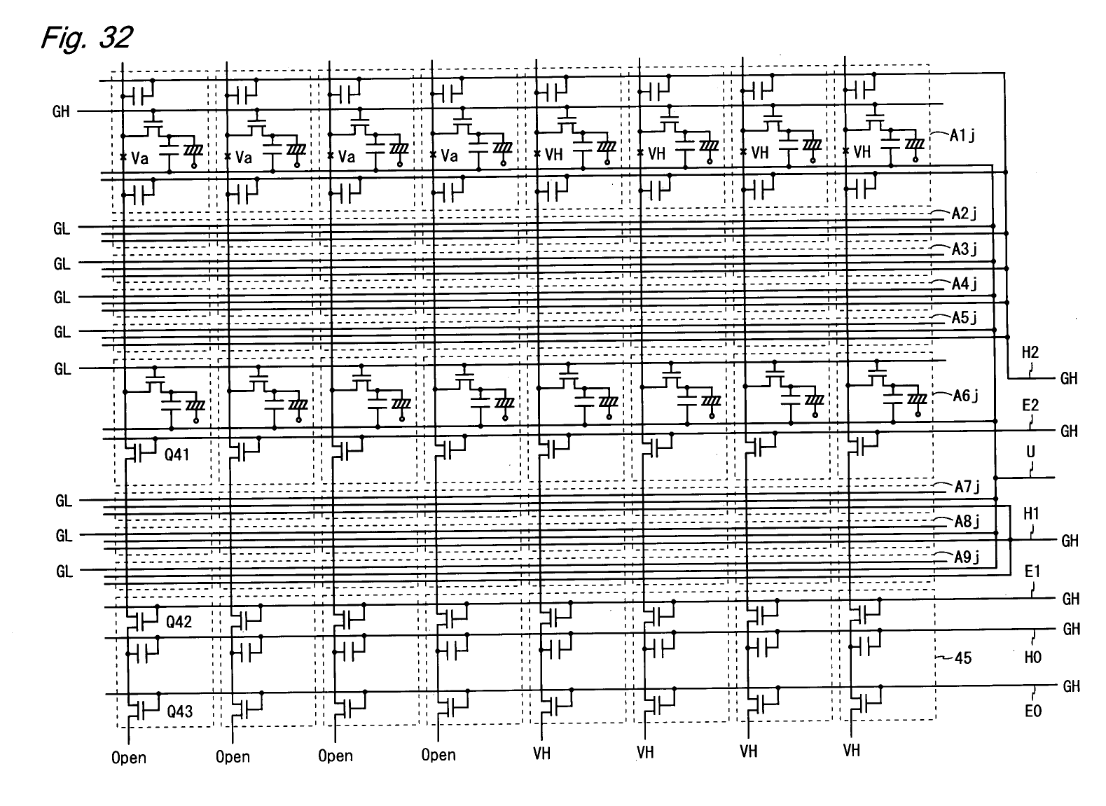

From time points t5 to t6, the control signal PV is DL, and therefore the selection output Dy is INV(Xj2), i.e., an inversion of the second bit in video data. When Xj2=0, the voltage selection circuit 44 outputs voltage VH, and when Xj2=1, the output terminal Bj of the voltage selection circuit 44 is in open state. Also, at time point t5, the capacitance control signals H2 to H0 change from GL to GH. Accordingly, when Xj2=0, the voltage on the sectional line Sj(2) is maintained at VH even after time point t5, but when X2j=1, the voltage changes to a predetermined level Va at time point t5 (see FIG. 32).

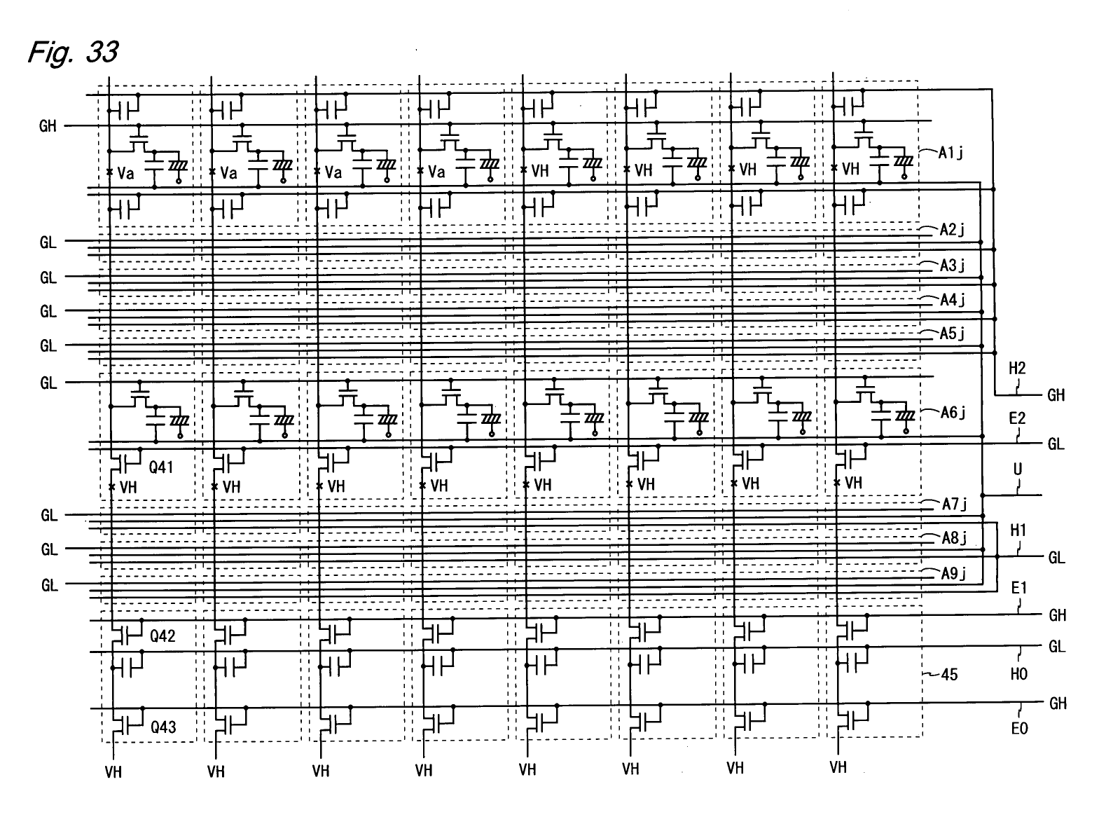

From time points t6 to t7, the control signal PV is DH, so that the selection output Dy is 1, and the voltage selection circuit 44 outputs voltage VH. At this time, the control signals E1 and E0 are DH and the control signal E2 is DL, so that the TFTs Q42 and Q43 are turned ON, and the TFT Q41 is turned OFF. Accordingly, the voltage on the sectional line Sj(2) is maintained at the same level, and the output voltage VH of the voltage selection circuit 44 is applied to the sectional lines Sj(1) and Sj(0). At this time, the capacitance control signal H2 is GH, and the capacitance control signals H1 and H0 are GL (see FIG. 33).

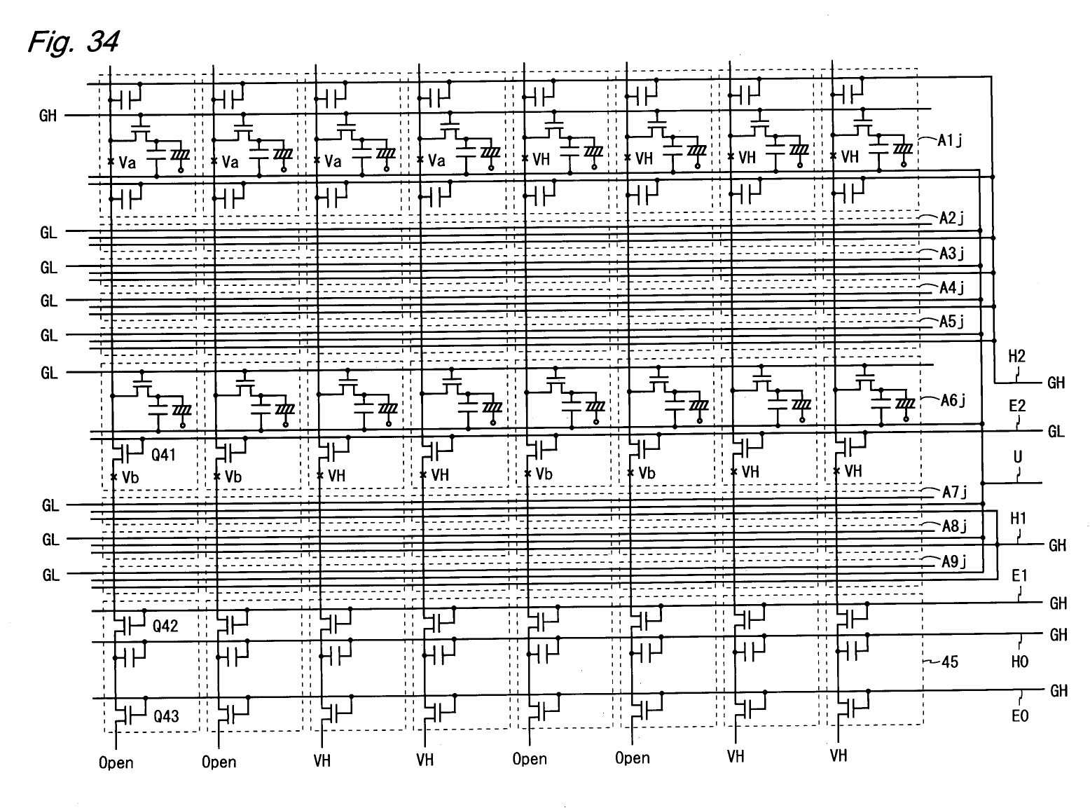

From time points t7 to t9, the control signal PV is DL, and therefore the selection output Dy is INV(Xj1). When Xj1=0, the voltage selection circuit 44 outputs voltage VH, and when Xj1=1, the output terminal Bj of the voltage selection circuit 44 is in open state. Also, at time point t8, the capacitance control signals H1 and H0 change from GL to GH. Accordingly, when Xj1=0, the voltage on the sectional line Sj(1) is maintained at VH even after time point t7, but when Xj1=1, the voltage changes to a predetermined level Vb at time point t8 (see FIG. 34).

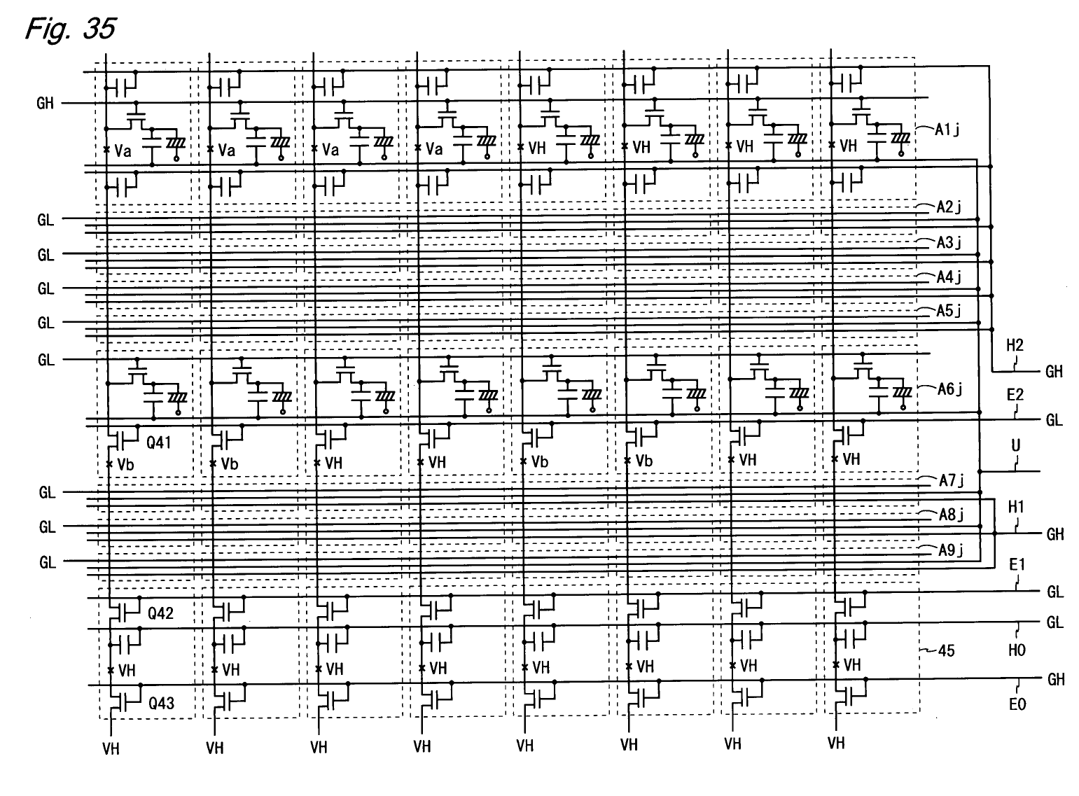

From time points t9 to t10, the control signal PV is DH, so that the selection output Dy is 1, and the voltage selection circuit 44 outputs voltage VH. At this time, the control signal E0 is DH, and the control signals E2 and E1 are DL, so that the TFT Q43 is turned ON, and the TFTs Q41 and Q42 are turned OFF. Accordingly, the voltage on the sectional lines Sj(2) and Sj(1) is maintained at the same level, and the output voltage VH of the voltage selection circuit 44 is applied to the sectional line Sj(0). At this time, the capacitance control signals H2 and H1 are GH, and the capacitance control signal H0 is GL (see FIG. 35).

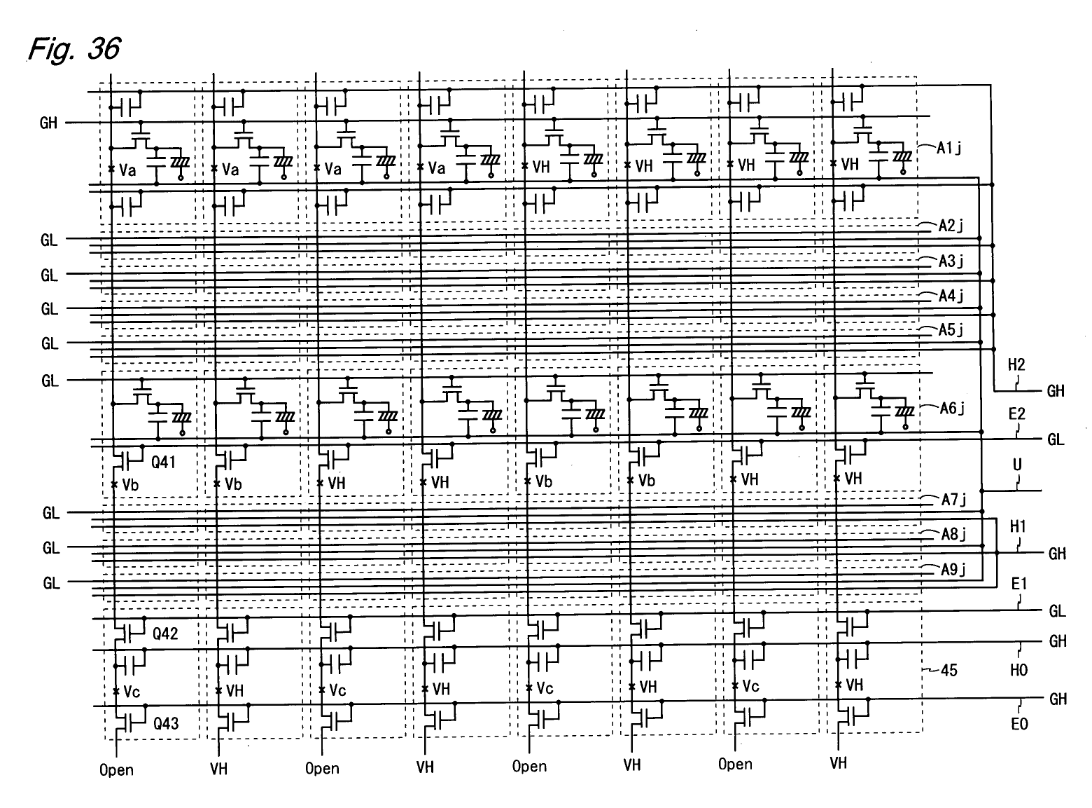

From time points t10 to t11, the control signal PV is DL, and therefore the selection output Dy is INV(Xj0). When Xj0=0, the voltage selection circuit 44 outputs voltage VH, and when Xj0=1, the output terminal Bj of the voltage selection circuit 44 is in open state. Also, at time point t10, the capacitance control signal H0 changes from GL to GH. Accordingly, when Xj0=0, the voltage on the sectional line Sj(0) is maintained at VH even after time point t10, but when Xj0=1, the voltage changes to a predetermined level Vc at time point t10 (see FIG. 36).

From time points t11 to t13, the control signals E2 and E1 are GH and the control signal E0 is GL, so that the TFTs Q41 and Q42 are turned ON, and the TFT Q43 is turned OFF. At this time, the sectional lines Sj(2) to Sj(0) are mutually connected via the TFTs Q41 and Q42, forming a single source line Sj. The voltage on the source line Sj at this time is equivalent to an average of the voltage applied to the sectional lines Sj(2) to Sj(0) from time points t4 to t11, as described below.

The total capacitance of the capacitors C1 to C6 is taken as Ca, other capacitances accompanying with the sectional line Sj(2) are taken as Cd, and voltage Vα is assumed to be applied to one terminal of the capacitance Cd. Charge accumulated on the sectional line Sj(2) does not change before and after time point t5, and therefore equation (7) below is established.

Ca(VH−GL)+Cd(VH−Vβ) =Ca(Va−GH)+Cd(Va−Vβ) (7)

The total capacitance of the capacitors C7 to C9 is taken as Cb, other capacitances accompanying with the sectional line Sj(1) are taken as Ce, and voltage Vβis assumed to be applied to one terminal of the capacitance Ce. Charge accumulated on the sectional line Sj(1) does not change before and after time point t8, and therefore equation (8) below is established.

Cb(VH−GL)+Ce(VH−Vβ)=Cb(Vb−GH)+Ce(Vb−Vβ) (8)

The capacitance of the capacitor C10 is taken as Cc, other capacitances accompanying with the sectional line Sj(0) are taken as Cf, and voltage Vγis assumed to be applied to one terminal of the capacitance Cf. Charge accumulated on the sectional line Sj(0) does not change before and after time point t10, and therefore equation (9) below is established.

Cc(VH−GL)+Cf(VH−Vγ)=Cc(Vc−GH)+Cf(Vc−Vγ) (9)

From equations (7) to (9), equations (10) to (12) below are obtained.

Va=VH+{Ca(GH−GL)}/(Ca+Cd) (10)

Vb=VH+{Cb(GH−GL)}/(Cb+Ce) (11)

Vc=VH+{Cc(GH−GL)}/(Cc+Cf) (12)

When the value of the video data is 7, the voltages applied to the sectional lines Sj(2) to Sj(0) from time points t4 to t11 are Va, Vb, and Vc, respectively, and the voltage on the source line Sj from time points t11 to t13 is V7 (see the leftmost source lines in FIGS. 30 to 37). Charge accumulated on the sectional lines Sj(2) to Sj(0) does not change before and after time point t11, and therefore the following equation is established.

(Ca+Cd)Va+(Cb+Ce)Vb+(Cc+Cf)Vc=(Ca+Cb+Cc+Cd+Ce+Cf)V7

Accordingly, when (Ca+Cd) is represented by Ca, (Cb+Ce) is represented by Cβ, (Cc+Cf) is represented by Cγ, and (Ca+Cb+Cc+Cd+Ce+Cf) is represented by Cs, voltage V7 is obtained by equation (13) below. Similarly, voltages V6 to V1 are respectively obtained by equations (14) to (19) below.

V7=(Cα·Va+Cβ·Vb+Cγ·Vc)/Cs (13)

V6=(Cα·Va+Cβ·Vb+Cγ·VH)/Cs (14)

V5=(Cα·Va+Cβ·VH+Cγ·Vc)/Cs (15)

V4=(Cα·Va+Cβ·VH+Cγ·VH)/Cs (16)

V3=(Cα·VH+Cβ·Vb+Cγ·Vc)/Cs (17)

V2=(Cα·VH+Cβ·Vb+Cγ·VH)/Cs (18)

V1=(Cα·VH+Cβ·VH+Cγ·Vc)/Cs (19)

As a result, for example, when 3Ca=Cd, 3Cb=Ce, 3Cc=Cf, Ca:Cb:Cc=4:2:1, GH=12V, GL=−8V, and VH=5V, from equations (10) to (12), Va=Vb=Vc=10V. Also, from equations (13) to (19), voltages V7 to V1 are obtained as shown below.

V7=(4Va+2Vb+Vc)/7=(7×10)/7=10

V6=(4Va+2Vb+VH)/7=(6×10+5)/7=65/7

V5=(4Va+2VH+Vc)/7=(5×10+2×5)/7=60/7

V4=(4Va+2VH+VH)/7=(4×10+3×5)/7=55/7

V3=(4VH+2Vb+Vc)/7=(3×10+4×5)/7=50/7

V2=(4VH+2Vb+VH)/7=(2×10+5×5)/7=45/7

V1=(4VH+2VH+Vc)/7=(10+6×5)/7=40/7

In this manner, when the polarity control signal Rv is DL, the voltage on the source line Sj is any one of eight levels of voltage from 5V to 10V in accordance with the value of the video data. On the other hand, when the polarity control signal Rv is DH, the output voltage of the voltage selection circuit 44 is VL, and the voltage on the source line Sj is any one of eight levels of voltage from −5V to 0V in accordance with the value of the video data. From time points t11 to t13, the gate signal G1 is GH, and therefore the voltage on the source line Sj is applied to the pixel electrode P1j in the pixel circuit A1j.

A common electrode driver circuit (not shown) of the display device 4 controls the potential of the common electrode com to be (VH+VL)/2. As a result, when the polarity control signal Rv is DL, voltage (positive gradation voltage) from 3V to 8V is applicable to the liquid crystal element, and when the polarity control signal Rv is DH, voltage (negative gradation voltage) from −7V to −2V is applicable to the liquid crystal element Lc.

Note that in the case of the display device 4 also, the gate signal G1 may be GH during the entire one horizontal period, rather than only during the voltage averaging period within one horizontal period. Also, to prevent the capacitances on the sectional lines from fluctuating, for example, pixel circuits A0j and A10j for capacitance adjustments may be provided along with the pixel circuit Aij for display.

As described above, the display device 4 according to the present embodiment includes a plurality of gate lines G1, a plurality of source lines Sj, a plurality of pixel circuits Aij disposed at corresponding intersections of the gate lines G1 and the source lines Sj, a plurality of sectional lines Sj(2) to Sj(0) functioning as capacitances, which are formed by dividing their respective source lines Sj, first switching elements (TFTs Q43) provided between the capacitances and lines with a fixed potential VH or VL, second switching elements (TFTs Q41 and Q42) provided between the capacitances, and capacitance lines H2 to H0 crossing the source lines Sj.

During the voltage application period, the first switching element is turned ON, and the second switching elements start with both TFTs being turned ON, then with only the TFT Q42 being in ON state, and finally with both of them being in OFF state, so that voltage according with bits in video data is applied to the sectional lines Sj(2) to Sj(0), which form capacitors by crossing the capacitance lines H2 to H0. During the voltage averaging period, the first switching element is turned OFF and the second switching elements are turned ON, so that the voltage on the source line Sj is equivalent to an average of the voltage applied to the sectional lines Sj(2) to Sj(0). The averaged voltage is applied to the pixel electrode Pij in the pixel circuit Aij including an active element (TFT Q1) in ON state.

Accordingly, as with the display device 1 according to the first embodiment, the display device 4 according to the present embodiment makes it possible to generate gradation voltage in accordance with video data and apply the generated voltage to the pixel electrodes Pij, thereby displaying desired video, without using operational amplifier circuits (and buffer circuits). In addition, since operational amplifier circuits are not used, it is possible to eliminate current constantly flowing between power sources of operational amplifier circuits, thereby reducing power consumption of the display device, and realizing driver-monolithic display devices at high yield and at low cost. Furthermore, the display device 4 allows the voltage applied to the pixel electrode Pij to be greater in amplitude than the output voltage of the source driver circuit 41, e.g., V7>VH.

While the liquid crystal display devices including liquid crystal elements Lc as display elements have been described so far, an organic EL display device including organic EL display elements can be configured similarly. The organic EL display device includes pixel circuits 51, each including a TFT Q51, which is an active element for writing control, a TFT Q52, which is an active element for drive, an organic EL element OL, which is a display element, and a capacitor Ct, as shown in FIG. 39. A pixel electrode Pij is connected to a gate terminal of the TFT Q52 having source and drain terminals connected to a power source line Vp and the organic EL element OL, respectively.

The amount of luminescence of the organic EL element OL is determined by the amount of current flowing through the TFT Q52, which is determined by the difference in potential between the power source line Vp and the pixel electrode Pij. Accordingly, the organic EL display device similarly configured also makes it possible to generate gradation voltage in accordance with video data and apply the generated voltage to the pixel electrodes Pij, thereby displaying desired video, without using operational amplifier circuits (and buffer circuits).

In the pixel circuit 51, the threshold voltage and mobility of the TFT Q52 have influences on the amount of current flowing through the TFT Q52. Therefore, to reduce such influences, a pixel circuit 52 as shown in FIG. 40 may be used. In the pixel circuit 52, current flowing through the TFT Q52 partially flows through resistance R and returns to the gate terminal of the TFT Q52, and the gate terminal voltage of the TFT Q52 rises in accordance with the amount of luminescence of the organic EL element OL. Accordingly, the amount of luminescence of the organic EL element OL is less susceptible to the threshold voltage and mobility of the TFT Q52.

### INDUSTRIAL APPLICABILITY

The display device of the present invention is characterized by source lines being driven without using operational amplifier circuits, as well as by low-power consumption and high-yield features, and therefore can be used as any of various display devices, such as liquid crystal display devices and organic EL display devices.

1. A display device for providing a gradation display based on video data, comprising:
a plurality of scanning signal lines;
a plurality of data signal lines; and
a plurality of pixel circuits disposed at corresponding intersections of the scanning signal lines and the data signal lines,
wherein provided for each of the data signal lines are:
a plurality of capacitances, including a capacitance formed by the data signal line,
a first switching element provided between the capacitance and a fixed-potential line; and
a second switching element provided between the capacitances.

2. The display device according to claim 1, wherein two or more of the capacitances are formed by dividing the data signal line.

3. The display device according to claim 2, wherein at least part of the second switching element is disposed between the divided data signal lines, and a control line for the second switching element disposed at the position is spaced from an adjacent scanning signal line at approximately the same distance as that between the scanning signal lines.

4. The display device according to claim 1, wherein the fixed-potential line is provided in a plurality.

5. The display device according to claim 1, further comprising capacitance lines crossing the data signal lines.

6. The display device according to claim 1, wherein,
during a voltage application period, the second switching element is turned ON or OFF, so that voltage according with the video data is applied to each of the capacitances,
during a voltage averaging period, the first switching element is turned OFF and the second switching element is turned ON, so that the voltage applied to the capacitances is averaged, and
the averaged voltage is applied to a pixel electrode in a pixel circuit including an active element in ON state.

7. The display device according to claim 1, wherein the video data is inputted using a format in which equally weighted portions are collected from plural pieces of numerical data and sequentially transferred.
